(19) United States
(12) Patent Application Publication
(10) Pub. No.: US 2026/0197878 A1
(43) Pub. Date: Jul. 9, 2026

(54) DYNAMIC SWITCHING BETWEEN INTER-CELL AND INTRA-CELL MULTI-TRANSMISSION RECEPTION POINTS

(71) Applicant: QUALCOMM Incorporated, San Diego, CA (US)

(72) Inventors: Shaozhen GUO, Beijing (CN); Mostafa KHOSHNEVISAN, San Diego, CA (US)

(21) Appl. No.: 19/134,474

(22) PCT Filed: Jan. 16, 2023
(86) PCT No.: PCT/CN2023/072272

§ 371 Date: May 30, 2025

(51) Int. Cl. H04W 74/0833; H04W 56/00

(52) U.S. Cl. CPC H04W 74/0833; H04W 56/0045

(57) ABSTRACT

Methods, systems, and devices for wireless communications are described. A user equipment (UE) may receive a control message indicating a set of timing advance groups (TAGs), where a first TAG is associated with a first control resource set (CORESET) and a second TAG is associated with a second CORESET. In some examples, the UE may receive a downlink message of a random access procedure, where the downlink message includes one or more reserved bits indicating a TAG from the set of TAGs and the UE may select a TAG based on a rule for application of the one or more reserved bits. In some other examples, the UE may receive a downlink message triggering a random access channel procedure and indicating a state from a set of states and the UE may select a TAG based on the indicated state and a mode of the UE.

### CROSS REFERENCE

The present application for patent is a 371 national phase filing of International Patent Application No. PCT/CN2023/072272 by GUO et al., entitled “DYNAMIC SWITCHING BETWEEN INTER-CELL AND INTRA-CELL MULTI-TRANSMISSION RECEPTION POINTS,” filed Jan. 16, 2023, assigned to the assignee hereof, and expressly incorporated by reference herein.

### FIELD OF TECHNOLOGY

The following relates to wireless communications, including a physical random access channel (PRACH) enhancement for dynamic switching between inter-cell and intra-cell multi-transmission reception points (TRPs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support a physical random access channel (PRACH) enhancement for dynamic switching between inter-cell and intra-cell multi-transmission reception points (TRPs). Generally, the techniques described herein may enable a user equipment (UE) to implement one or more rules associated with interpreting one or more messages received by the UE to determine an timing advance group (TAG) associated with a TRP (e.g., associated with a control resource set (CORESET) pool index). For example, the UE may receive a control message indicating a set of TAGs, where a first TAG from the set of TAGs is associated with a first CORESET pool index (e.g., associated with a TRP or network entity) and a second TAG from the set of TAGs is associated with a second CORESET pool index (e.g., CORESET pool index value). Additionally, the first CORESET pool index may be associated with a serving cell physical cell identifier (PCI). In some examples, the UE may receive, in response to an initial uplink message of a random access procedure, a first downlink message of the random access procedure, where the first downlink message includes one or more reserved bits that indicate one of the first TAG or the second TAG. In such cases, the UE may select one of the first TAG or the second TAG based on a rule for application of the one or more reserved bits and may communicate in accordance with the selected TAG based on the selection.

In some other examples, the UE may receive a different downlink message that triggers a random access procedure, where the different downlink message indicates a state from a set of states. Each state from the set of states may be associated with a PCI from a set of PCIs and may indicate a TAG that is to be used by the UE. In such cases, the UE may select a TAG from the first TAG or the second TAG based on the indicated state and a multi-TRP mode of the UE. Additionally, the UE may transmit an uplink message using the selected TAG.

A method for wireless communications at a UE is described. The method may include receiving a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI, receiving, in response to an initial uplink message of a random access procedure, a first downlink message of the random access procedure, the first downlink message including one or more reserved bits that indicate one of the first TAG or the second TAG, selecting one of the first TAG or the second TAG based on a rule for application of the one or more reserved bits, and communicating in accordance with a selected TAG, which is one of the first TAG or the second TAG, based on the selection.

An apparatus for wireless communications at a UE is described. The apparatus may include a processor, memory coupled with the processor, and instructions stored in the memory. The instructions may be executable by the processor to cause the apparatus to receive a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI, receive, in response to an initial uplink message of a random access procedure, a first downlink message of the random access procedure, the first downlink message including one or more reserved bits that indicate one of the first TAG or the second TAG, select one of the first TAG or the second TAG based on a rule for application of the one or more reserved bits, and communicating in accordance with a select TAG, which is one of the first TAG or the second TAG, based on the selection.

Another apparatus for wireless communications at a UE is described. The apparatus may include means for receiving a control message indicating a set of TAGS, where a first TAG from the set of TAGs is associated with a first CORESET pool index and a second TAG from the set of TAGs is associated with a second CORESET pool index, and where the first CORESET pool index is associated with a serving PCI, means for receiving, in response to an initial uplink message of a random access procedure, a first downlink message of the random access procedure, the first downlink message including one or more reserved bits that indicate one of the first TAG or the second TAG, means for selecting one of the first TAG or the second TAG based on a rule for application of the one or more reserved bits, and means for communicating in accordance with a selected TAG, which is one of the first TAG or the second TAG, based on the selection.

A non-transitory computer-readable medium storing code for wireless communications at a UE is described. The code may include instructions executable by a processor to receive a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI, receive, in response to an initial uplink message of a random access procedure, a first downlink message of the random access procedure, the first downlink message including one or more reserved bits that indicate one of the first TAG or the second TAG, select one of the first TAG or the second TAG based on a rule for application of the one or more reserved bits, and communicating in accordance with a select TAG, which is one of the first TAG or the second TAG, based on the selection.

Some examples of the method, apparatuses, and non-transitory computer-readable medium described herein may further include operations, features, means, or instructions for receiving a second downlink message that triggers the random access procedure and associates the random access procedure with the serving PCI or an additional PCI that may be different from the serving PCI, where the rule for application of the one or more reserved bits may be based on the random access procedure being associated with the serving PCI or the additional PCI.

In some examples of the method, apparatuses, and non-transitory computer-readable medium described herein, the random access procedure may be associated with the additional PCI and the rule for application of the one or more reserved bits may be indicative that the UE may be to ignore the one or more reserved bits based on the random access procedure being associated with the additional PCI.

In some examples of the method, apparatuses, and non-transitory computer-readable medium described herein, selecting one of the first TAG or the second TAG may include operations, features, means, or instructions for selecting the selected TAG based on a configuration associated with the additional PCI.

In some examples of the method, apparatuses, and non-transitory computer-readable medium described herein, selecting one of the first TAG or the second TAG may include operations, features, means, or instructions for selecting the selected TAG based on the indication of the one or more reserved bits.

In some examples of the method, apparatuses, and non-transitory computer-readable medium described herein, the selected TAG may be the second TAG and the method, apparatuses, and non-transitory computer-readable medium may include further operations, features, means, or instructions for delaying the communicating in accordance with the second TAG based on the UE operating in an inter-cell mode at a time the first downlink message may be received or may be to be applied, where the second CORESET pool index being associated with one or more TCI states that may be associated with an additional PCI may be indicative that the UE may be operating in the inter-cell mode.

In some examples of the method, apparatuses, and non-transitory computer-readable medium described herein, communicating in accordance with the selected TAG may include operations, features, means, or instructions for communicating in accordance with the second TAG, after the delaying, based on the second CORESET pool index being associated with one or more TCI states that may be associated with the serving PCI as a result of activation of the serving PCI for the second CORESET pool index.

In some examples of the method, apparatuses, and non-transitory computer-readable medium described herein, communicating in accordance with the selected TAG may include operations, features, means, or instructions for communicating in accordance with the selected TAG based on the UE operating in an intra-cell mode at a time the first downlink message may be received or may be to be applied, where both the first CORESET pool index and the second CORESET pool index being associated with one or more TCI states that may be associated with the serving PCI may be indicative that the UE may be operating in the intra-cell mode.

In some examples of the method, apparatuses, and non-transitory computer-readable medium described herein, the rule for application of the one or more reserved bits may be based on a multi TRP communication mode of the UE at a time the first downlink message may be received or may be to be applied.

In some examples of the method, apparatuses, and non-transitory computer-readable medium described herein, the multi TRP communication mode of the UE may be an inter-cell mode and the rule for application of the one or more reserved bits may be indicative that the UE may be to ignore the one or more reserved bits based on the UE being in the inter-cell mode, as indicated by at least one active TCI state of the UE being associated with an additional PCI that may be different from the serving PCI.

In some examples of the method, apparatuses, and non-transitory computer-readable medium described herein, the multi TRP communication mode of the UE may be an intra-cell mode and the rule for application of the one or more reserved bits may be indicative that the UE may be to select the selected TAG using the one or more reserved bits based on the UE being in the intra-cell mode, as indicated by all active TCI states of the UE being associated with the serving PCI.

In some examples of the method, apparatuses, and non-transitory computer-readable medium described herein, the first downlink message of the random access procedure may be a RAR message or an absolute TA command MAC-CE.

A method for wireless communications at a UE is described. The method may include receiving a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI, receiving a downlink message that triggers a random access procedure, the downlink message indicating a state from a set of states, where each state from the set of states is associated with a PCI from a set of PCIs and is indicative of a TAG that is to be used by the UE, selecting a selected TAG from the first TAG, or the second TAG based on the indicated state and on a multi TRP communication mode of the UE, and transmitting an uplink message using the selected TAG.

An apparatus for wireless communications at a UE is described. The apparatus may include a processor, memory coupled with the processor, and instructions stored in the memory. The instructions may be executable by the processor to cause the apparatus to receive a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI, receive a downlink message that triggers a random access procedure, the downlink message indicating a state from a set of states, where each state from the set of states is associated with a PCI from a set of PCIs and is indicative of a TAG that is to be used by the UE, select a selected TAG from the first TAG, or the second TAG based on the indicated state and on a multi TRP communication mode of the UE, and transmit an uplink message using the selected TAG.

Another apparatus for wireless communications at a UE is described. The apparatus may include means for receiving a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI, means for receiving a downlink message that triggers a random access procedure, the downlink message indicating a state from a set of states, where each state from the set of states is associated with a PCI from a set of PCIs and is indicative of a TAG that is to be used by the UE, means for selecting a selected TAG from the first TAG, or the second TAG based on the indicated state and on a multi TRP communication mode of the UE, and means for transmitting an uplink message using the selected TAG.

A non-transitory computer-readable medium storing code for wireless communications at a UE is described. The code may include instructions executable by a processor to receive a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI, receive a downlink message that triggers a random access procedure, the downlink message indicating a state from a set of states, where each state from the set of states is associated with a PCI from a set of PCIs and is indicative of a TAG that is to be used by the UE, select a selected TAG from the first TAG, or the second TAG based on the indicated state and on a multi TRP communication mode of the UE, and transmit an uplink message using the selected TAG.

In some examples of the method, apparatuses, and non-transitory computer-readable medium described herein, the set of states includes a first state indicating the first TAG associated with the serving PCI from the set of PCIs, a second state indicating the second TAG associated with the serving PCI, and one or more third states each indicating for the UE to transmit the uplink message in accordance with a random access procedure configuration associated with respective additional PCIs from the set of PCIs.

In some examples of the method, apparatuses, and non-transitory computer-readable medium described herein, the selected TAG may be the second TAG and the method, apparatuses, and non-transitory computer-readable medium may include further operations, features, means, or instructions for transmitting an initial uplink message of the random access procedure, receiving a second downlink message in response to the initial uplink message, where the second downlink message includes a TA command associated with the indicated state, and delaying the transmission of the uplink message using the second TAG based on the UE operating in an inter-cell multi TRP communication mode at a time the second downlink message may be received or may be to be applied, where the second CORESET pool index being associated with one or more TCI states that may be associated with an additional PCI may be indicative that the UE may be operating in the inter-cell multi TRP communication mode.

In some examples of the method, apparatuses, and non-transitory computer-readable medium described herein, transmitting the uplink message may include operations, features, means, or instructions for transmitting the uplink message in accordance with the second TAG, after the delaying, based on the second CORESET pool index being associated with the one or more TCI states that may be associated with the serving PCI as a result of activation of the serving PCI for the second CORESET pool index.

In some examples of the method, apparatuses, and non-transitory computer-readable medium described herein, a quantity of the set of states may be based on the multi TRP communication mode of the UE at a time the downlink message may be received or an initial uplink message of the random access procedure may be transmitted.

Some examples of the method, apparatuses, and non-transitory computer-readable medium described herein may further include operations, features, means, or instructions for operating the UE in an intra-cell multi TRP mode at the time the downlink message may be received or the initial uplink message of the random access procedure may be transmitted, where the set of states includes a first state indicating the first TAG associated with the serving PCI from the set of PCIs and a second state indicating the second TAG associated with the serving PCI.

In some examples of the method, apparatuses, and non-transitory computer-readable medium described herein, operation of the UE in the intra-cell multi TRP mode may be indicated by the first CORESET pool index and the second CORESET pool index being associated with the serving PCI.

Some examples of the method, apparatuses, and non-transitory computer-readable medium described herein may further include operations, features, means, or instructions for operating the UE in an inter-cell multi TRP mode at the time the downlink message may be received or the initial uplink message of the random access procedure may be transmitted, where the set of states includes a first state indicating for the UE to transmit the uplink message in accordance with a first random access procedure configuration associated with the serving PCI from the set of PCIs and one or more second states indicating for the UE to transmit the uplink message in accordance with a respective random access configuration procedure configuration associated with each additional PCI from the set of PCIs.

In some examples of the method, apparatuses, and non-transitory computer-readable medium described herein, operation of the UE in the inter-cell multi TRP mode may be indicated by the first CORESET pool index being associated with the serving PCI and the second CORESET pool index being associated with an additional PCI.

In some examples of the method, apparatuses, and non-transitory computer-readable medium described herein, the set of states includes a first state indicating whether the random access procedure may be associated with an inter-cell multi TRP communication mode or an intra-cell multi TRP communication mode, a second state indicating for the UE to transmit the uplink message in accordance with a first random access procedure configuration associated with the serving PCI from the set of PCIs, and one or more third states each indicating for the UE to transmit the uplink message in accordance with a random access procedure configuration associated with respective additional PCIs from the set of PCIs.

In some examples of the method, apparatuses, and non-transitory computer-readable medium described herein, selecting the selected TAG may include operations, features, means, or instructions for determining the selected TAG based on a CORESET pool index associated with the downlink message triggering the random access procedure.

Some examples of the method, apparatuses, and non-transitory computer-readable medium described herein may further include operations, features, means, or instructions for transmitting an initial uplink message of the random access procedure, receiving a second downlink message in response to the initial uplink message, where the second downlink message includes a TA command associated with the second CORESET pool index, and delaying the transmission of the uplink message in accordance with the selected TAG based on the UE operating in the inter-cell multi TRP communication mode at a time the second downlink message may be received or may be to be applied, where the second CORESET pool index being associated with one or more TCI states that may be associated with an additional PCI may be indicative that the UE may be operating in the inter-cell multi TRP communication mode.

In some examples of the method, apparatuses, and non-transitory computer-readable medium described herein, transmitting the uplink message may include operations, features, means, or instructions for transmitting the uplink message in accordance with the second TAG, after the delaying, based on the second CORESET pool index being associated with one or more TCI states that may be associated with the serving PCI as a result of activation of the serving PCI for the second CORESET pool index.

In some examples of the method, apparatuses, and non-transitory computer-readable medium described herein, selecting the selected TAG may include operations, features, means, or instructions for determining the selected TAG based on the indicated state in the downlink message triggering the random access procedure.

In some examples of the method, apparatuses, and non-transitory computer-readable medium described herein, the set of states includes a first state indicating for the UE to transmit the uplink message in accordance with a first random access procedure configuration associated with the serving PCI from the set of PCIs and one or more second states indicating for the UE to transmit the uplink message in accordance with an respective random access configuration procedure configuration associated with respective additional PCIs from the set of PCIs.

In some examples of the method, apparatuses, and non-transitory computer-readable medium described herein, selecting the selected TAG may include operations, features, means, or instructions for selecting the selected TAG based on a CORESET pool index associated with the downlink message triggering the random access procedure and based on the UE operating in an intra-cell multi TRP communication mode at a time the downlink message may be received or an initial uplink message of the random access procedure may be transmitted.

In some examples of the method, apparatuses, and non-transitory computer-readable medium described herein, selecting the selected TAG may include operations, features, means, or instructions for selecting the selected TAG based on the indicated state and based on the UE operating in an inter-cell multi TRP communication mode at a time downlink message may be received or an initial uplink message of the random access procedure may be transmitted.

In some examples of the method, apparatuses, and non-transitory computer-readable medium described herein, the downlink message that triggers the random access procedure may be a PDCCH order DCI.

### BRIEF DESCRIPTION OF THE DRAWINGS

FIG. 1 illustrates an example of a wireless communications system that supports a physical random access channel (PRACH) enhancement for dynamic switching between inter-cell and intra-cell multi-transmission reception points (TRPs) in accordance with one or more aspects of the present disclosure

FIG. 2 illustrates an example of a wireless communications system that supports PRACH enhancements for dynamic switching between inter-cell and intra-cell multi-TRPs in accordance with one or more aspects of the present disclosure.

FIGS. 3 through 8 illustrate examples of timing diagrams that supports PRACH enhancements for dynamic switching between inter-cell and intra-cell multi-TRPs in accordance with one or more aspects of the present disclosure.

FIG. 9 illustrates an example of a process flow that supports PRACH enhancements for dynamic switching between inter-cell and intra-cell multi-TRPs in accordance with one or more aspects of the present disclosure.

FIG. 10 illustrates an example of a process flow that supports PRACH enhancements for dynamic switching between inter-cell and intra-cell multi-TRPs in accordance with one or more aspects of the present disclosure.

FIGS. 11 and 12 illustrate block diagrams of devices that support PRACH enhancements for dynamic switching between inter-cell and intra-cell multi-TRPs in accordance with one or more aspects of the present disclosure.

FIG. 13 illustrates a block diagram of a communications manager that supports PRACH enhancements for dynamic switching between inter-cell and intra-cell multi-TRPs in accordance with one or more aspects of the present disclosure.

FIG. 14 illustrates a diagram of a system including a device that supports PRACH enhancements for dynamic switching between inter-cell and intra-cell multi-TRPs in accordance with one or more aspects of the present disclosure.

FIGS. 15 and 16 illustrate flowcharts showing methods that support PRACH enhancements for dynamic switching between inter-cell and intra-cell multi-TRPs in accordance with one or more aspects of the present disclosure.

### DETAILED DESCRIPTION

Some wireless communications systems may support transmissions to or from a single user equipment (UE) with multiple transmission reception points (TRPs). Additionally, each TRP may be associated with a same cell (e.g., a serving cell) or with different cells (e.g., a serving cell and one or more additional cells). In some examples, each TRP may transmit a control message (e.g., downlink control information (DCI)) scheduling respective communications between the TRP and the UE. For example, a first control message transmitted from a first TRP may schedule communications between the UE and the first TRP, and a second control message transmitted from a second TRP may schedule communications between the UE and the second TRP. In some examples, the UE may determine which TRP a control message is associated with based on the respective control resource set (CORESET) in which the control message is received (e.g., based on a CORESET pool index associated with the control message). That is, each TRP may be associated with a CORESET pool index, and each CORESET may also be associated with a CORESET pool index, such that each TRP may be associated with a unique CORESET pool. Additionally, each TRP may be associated with a physical cell identifier (PCI). In some examples, the TRPs may be associated with a same PCI and, in such cases, the UE may operate in an intra-cell mode. Alternatively, the TRPs may be associated with different PCIs and, in such cases, the UE may operate in an inter-cell mode. In some cases, the UE may dynamically switch between the intra-cell mode and the inter-cell mode.

In some examples, such as when the UE communicates with the multiple TRPs, the UE may apply different timing advances (TAs) to communications with each TRP. That is, the UE may determine which TA to apply to communications with a TRP based on a relationship between the TRP and a timing advance group (TAG). In other words, a TRP may indicate a TAG to the UE during a random access channel (RACH) procedure, such that the UE may apply a TA associated with the indicated TAG to communications with the TRP. In some examples, the TRP may indicate a RACH configuration associated with a given PCI and the UE may determine the TAG based on the PCI. Alternatively, the TRP may indicate the TAG via one or more reserved bits in a random access response (RAR) message or in an absolute TA command MAC CE (e.g., during the RACH procedure). However, due to the multiple methods for indicating the TAG, conflicts may exist between indicated TAGs. For example, some methods for indicating a TAG may be associated with the UE operating in the intra-cell mode while other methods may be associated with the UE operating in the inter-cell mode. As such, a conflict may exist between an operational mode of the UE and a method in which a TAG is indicated to a UE.

Accordingly, techniques described herein support implementation of one or more rules associated with interpreting one or more messages received by the UE to determine a TAG associated with a given TRP (e.g., based on the UE supporting dynamic switching between the inter-cell mode and the intra-cell mode). In some examples, a rule may indicate whether the UE may use or ignore a TAG indication via one or more reserved bits in an RAR message or absolute TA command MAC CE. That is, in an inter-cell TRP scenario, a TRP may indicate a TAG via a PCI-associated RACH configuration rather than the one or more reserved bits, such that the UE may ignore a TAG indication in the one or more reserved bits. Alternatively, in an intra-cell TRP scenario, a TRP may indicate a TAG in the one or more reserved bits, such that the UE may use a TAG indication in the one or more reserved bits. As such, a rule may indicate for the UE to determine whether to apply or ignore the one or more reserved bits. For example, if a RAR or absolute TA command MAC CE is in response to a RACH procedure associated with an additional cell (e.g., other than a current serving cell), the UE may ignore the one or more reserved bits. Alternatively, if a RAR or absolute TA command MAC CE is in response toa RACH procedure associated with a serving cell or the RACH procedure is initiated by the UE, the UE may use the one or more reserved bits in the RAR message or absolute TA command MAC CE to determine a respective TAG. In some other examples, the rule may indicate for the UE to determine whether to apply or ignore the one or more reserved bits based on an operational mode of the UE (e.g., intra-cell mode or inter-cell mode).

Additionally, or alternatively, the UE may receive a control message including an order to initiate a RACH procedure and the order may indicate a state associated with a PCI and, or may directly indicate a TAG associated with serving PCI. As such, the UE may apply the indicated state based an operational mode of the UE (e.g., intra-cell mode or inter-cell mode). In some examples, the control message may indicate the operational mode in addition to the indicated state.

Aspects of the disclosure are initially described in the context of wireless communications systems. Aspects of the disclosure are then described in the context of timing diagrams and process flows. Aspects of the disclosure are further illustrated by and described with reference to apparatus diagrams, system diagrams, and flowcharts that relate to PRACH enhancements for dynamic switching between inter-cell and intra-cell multi-TRPs.

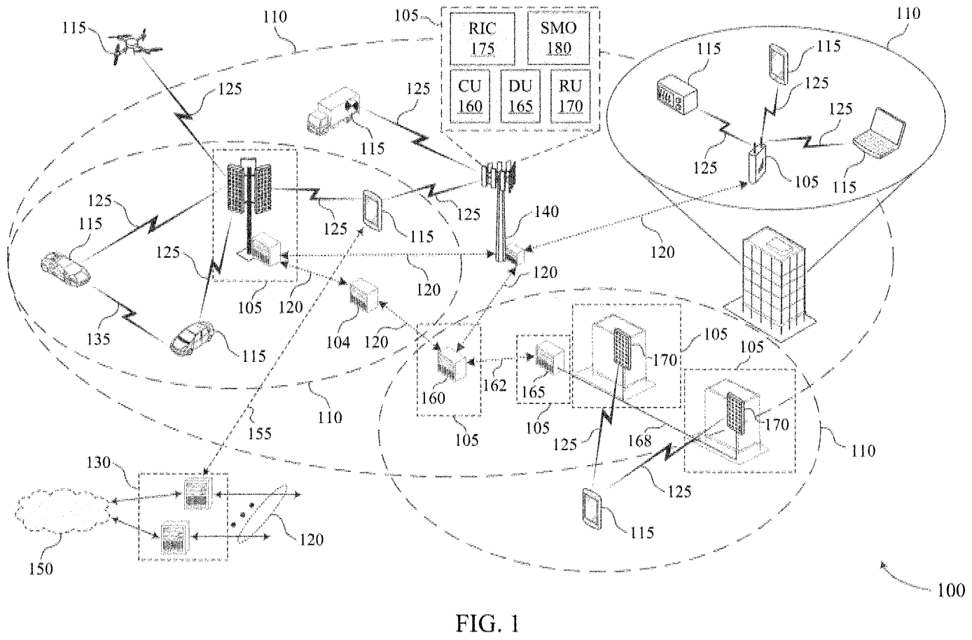

FIG. 1 illustrates an example of a wireless communications system 100 that supports PRACH enhancements for dynamic switching between inter-cell and intra-cell multi-TRPs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (LAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support PRACH enhancements for dynamic switching between inter-cell and intra-cell multi-TRPs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology)

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a PCID, a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support techniques enabling a UE 115 to receive an indication of one or more rules associated with interpreting one or more messages received by the UE 115 to determine a TAG associated with a given TRP (e.g., network entity 105). In some examples, a rule may indicate whether the UE 115 may use or ignore a TAG indication via one or more reserved bits in an RAR message. That is, in an inter-cell TRP scenario, a TRP may indicate a TAG via a PCI-associated RACH configuration rather than the one or more reserved bits, such that the UE 115 may ignore a TAG indication in the one or more reserved bits. Alternatively, in an intra-cell TRP scenario, a TRP may indicate a TAG in the one or more reserved bits, such that the UE 115 may use a TAG indication in the one or more reserved bits. As such, a rule may indicate for the UE 115 to determine whether to apply or ignore the one or more reserved bits. For example, if a RACH associated with a RACH procedure is further associated with an additional cell (e.g., other than a current serving cell), the UE 115 may ignore the one or more reserved bits. Alternatively, if a RACH associated with a RACH procedure is further associated with a serving cell or the RACH procedure is initiated by the UE 115, the UE 115 may use the one or more reserved bits in the RAR message to determine a respective TAG. In some other examples, the rule may indicate for the UE 115 to determine whether to apply or ignore the one or more reserved bits based on an operational mode of the UE 115 (e.g., intra-cell mode or inter-cell mode).

Additionally, or alternatively, the UE 115 may receive a control message including an order to initiate a RACH procedure and the order may indicate a state associated with a PCI, or may directly indicate a TAG, As such, the UE 115 may apply the indicated state based an operational mode of the UE 115 (e.g., intra-cell mode or inter-cell mode). In some examples, the control message may indicate the operational mode in addition to the indicated state.

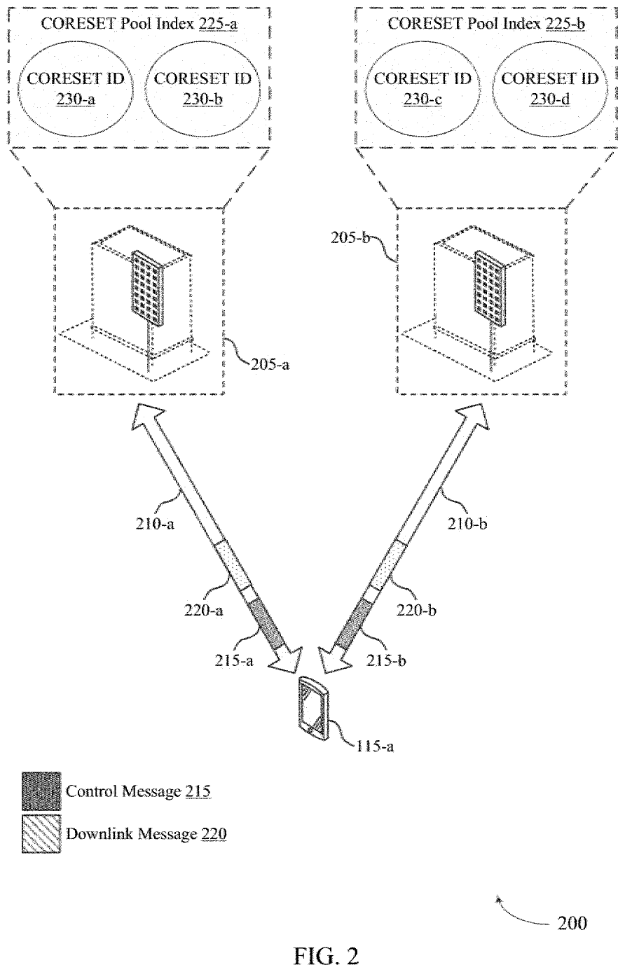

FIG. 2 illustrates an example of a wireless communications system 200 that supports PRACH enhancements for dynamic switching between inter-cell and intra-cell multi-TRPs in accordance with one or more aspects of the present disclosure. In some examples, the wireless communications system 200 may implement or be implemented by aspects of the wireless communications system 100. For example, the wireless communications system 200 may include one or more network entities 105 (e.g., associated with one or more TRPs 205, such as a TRP 205-a and a TRP 205-b) and one or more UEs 115 (e.g., a UE 115-a), which may be examples of the corresponding devices as described with reference to FIG. 1. In some examples, the UE 115-a may implement one or more rules associated with interpreting one or more messages received by the UE 115-a to determine a TAG associated with the network entity 105-a or the network entity 105-b.

Some wireless communications systems, such as the wireless communications system 200, may support transmissions to or from a single UE 115, such as the UE 115-a, with multiple TRPs, such as the TRP 205-a and the TRP 205-b, via multiple communication links, such as a communication link 210-a and a communication link 210-b, respectively (e.g., support multi-TRP communications). Additionally, each TRP 205 may be associated with a same cell (e.g., a serving cell) or with different cells (e.g., a serving cell and an additional cell).

In some examples, each TRP 205 may transmit a control message 215 (e.g., downlink control information (DCI)) scheduling respective communications between the TRP 205 and the UE 115-a (e.g., multi-DCI communications). For example, the TRP 205-a may transmit, to the UE 115-a, a control message 215-a scheduling a downlink message 220-a from the TRP 205-a to the UE 115-a and the TRP 205-b may transmit, to the UE 115-a, a control message 215-b scheduling a downlink message 220-b from the TRP 205-b to the UE 115-a.

In some examples, the UE 115-a may determine which TRP 205 is associated with a control message 215 based on a respective CORESET in which the control message 215 is received by the UE 115-a (e.g., is associated with the control message 215). That is, each TRP 205 may be associated with a CORESET pool index 225 (e.g., value of a CORESET pool index 225) and each CORESET (e.g., maximum of 5) may also be associated with a CORESET pool index 225, such that each TRP 205 may be associated with a unique CORESET pool. As such, each control message 215 may be associated with a CORESET identifier (ID) 230 further associated with a CORESET pool index 225 (i.e., a TRP ID). For example, the TRP 205-a may be associated with a CORESET pool index 225-a (e.g., CORESETPoolIndex=0), such that the control message 215-a may be associated with (e.g., include an indication of) a CORESET ID 230-a (e.g., equal to 1) or a CORESET ID 230-b (e.g., equal to 2), where the CORESET ID 230-a and the CORESET ID 230-b are associated with the CORESET pool index 225-a. Similarly, the TRP 205-b may be associated with a CORESET pool index 225-b (e.g., CORESETPoolIndex=1), such that the control message 215-b may include an indication of a CORESET ID 230-c (e.g., equal to 3) or a CORESET ID 230-d (e.g., equal to 4), where the CORESET ID 230-c and the CORESET ID 230-d are associated with the CORESET pool index 225-b. In some examples, the UE 115-a may receive a control message 215 indicating the CORESET pool index 215-a and the CORESET pool index 215-b in CORESETs associated with an active bandwidth part (BWP) of a serving cell. That is, the UE 115-a may be configured with multi-DCI based multi-TRP communications in a given component carrier (CC) based on the UE 115-a being configured with multiple CORESET pool indices 225 in the CORESETs for the active BWP of the serving cell (e.g., the higher layer parameter PDCCH-Config contains two different values of CORESET pool index 225 in CORESETs for the active BWP of the serving cell).

In some examples, such as when the UE 115-a communicates with the multiple TRPs 205 (e.g., operates in a multi-TRP configuration), the UE 115-a may apply different TAs to communications with each TRP 205. That is, the UE 115-a may determine which TA to apply to communications with a TRP 205 based on a relationship between the TRP 205 and a TAG (e.g., two TAGs are configured and used). In other words, a TRP 205-a may be associated with a TAG and may indicate, to the UE 115-a during a RACH procedure, (e.g., random access procedure) the TAG, such that the UE 115-a may apply a TA associated with the indicated TAG to communications with the respective TRP 205. For example, the TRP 205-a may be associated with a first TAG and the TRP 205-b may be associated with a second TAG. As such, the TRP 205-a may indicate, to the UE 115-a, the first TAG (e.g., TAG1) during a first RACH procedure associated with the TRP 205-a and the TRP 205-b may indicate, to the UE 115-a, the second TAG (e.g., TAG2) during a second RACH procedure associated with the TRP 205-b. As such, the UE 115-a may apply a first TA associated with the first TAG to communications with the TRP 205-a and a second TA associated with the second TAG to communications with the TRP 205-b.

In some examples, a CORESET pool index may be associated with one or more TCI states, which may be activated in connection with a cell (e.g., serving cell or additional cell). For example, the UE 115-a may receive a first control message 215 indicating (e.g., be RRC configured with PDSCH-Config including) a list of TCI states including a quantity of TCI states (e.g., a list of up to M candidate TCI states, M=128). In some examples, the list of TCI states may be associated with (e.g., configured/defined) a physical downlink shared channel (PDSCH) configuration (e.g., PDSCH-Config). Additionally, an identifier associated with each TCI state (e.g., TCI-StateID) may be associated with (e.g., used for configuring) a CORESET, one or more resources (e.g., NZP-CSI-RS-Resources, physical uplink control channel (PUCCH) resources, SRS resources, etc.), or both.

In some examples, the UE 115-a may receive a second control message 215 (e.g., MAC-CE) activating at least a subset of TCI states (e.g., 2N TCI states) from the quantity of TCI states (e.g., M TCI states) included in the list of TCI states to indicate a QCL relationship for a given CORESET pool index 225 (e.g., for physical downlink control channel (PDCCH), MAC-CE activates one TCI state). Additionally, the UE 115-a may receive a third control message 215 (e.g., DCI) indicating one or more TCI states from the subset of TCI states associated with (e.g., for) a downlink message 220 associated with the given CORESET pool index 225 (e.g., N bits in the DCI may dynamically indicate TCI states for a PDSCH transmission). In some examples (e.g., multi-DCI based multi-TRP communications), the downlink message 220 may be associated with the given CORESET pool index 225 (e.g., value of the given CORESET pool index 225) of a CORESET in which the third control message 215 is received by the UE 115-a.

Additionally, each TRP 205 may be associated with a PCI. In some examples, the TRPs 205 may be associated with a same PCI, such as a first PCI (e.g., associated with the serving cell, such as a first network entity 105), and, in such cases, the UE 115-a may operate in an intra-cell mode (e.g., different panels and different remote radio heads (RRHs) of the same serving cell). In other words, the TRP 205-a and the TRP 205-b may be associated with a same network entity 105 (e.g., based on the TRPs 205 being associated with a same PCI). Alternatively, the TRPs 205 may be associated with different PCIs, such as the first PCI and a second PCI (e.g., the first PCI associated with the serving cell, such as the first network entity 105, and a second PCI associated with an additional cell, such as a second network entity 105) and, in such cases, the UE 115-a may operate in an inter-cell mode. In other words, the TRP 205-a may be associated with the first network entity 105 and the TRP 205-b may be associated with the second network entity 105 (e.g., based on the TRPs 205 being associated with different PCIs). In such cases (e.g., inter-cell mode), the UE 115-a may be aware of a single PCI at a given time (e.g., a PCI that the UE 115-a acquired during a cell search). In some examples, the UE 115-a may dynamically switch between the intra-cell mode and the inter-cell mode. Additionally, or alternatively, the first PCI (e.g., serving cell PCI) may be associated (e.g., always associated) with active TCI states (e.g., activated via the second control message 215) and the second PCI (e.g., only 1 additional PCI) may be associated with the active TCI states. In some examples (e.g., for inter-cell multi-TRP), the first PCI may be associated with one or more first activated TCI states for communications (e.g., PDSCH/PDCCH) associated with a first COREST Pool Index 225, such as the CORESET pool index 225-a (e.g., one COREST Pool Index 225), and the second PCI may be associated with one or more second activated TCI states for communications associated with a second COREST Pool Index 225, such as the CORESET pool index 225-b (e.g., another COREST Pool Index 225).

In some cases (e.g., inter-cell or intra-cell), a TRP 205 may indicate a TAG in a RACH configuration (e.g., physical RACH (PRACH) configuration), where the TAG is associated with one or more TCI states, which may be activated in connection with a cell. That is, the UE 115 may perform a RACH procedure, which may be a two-step RACH procedure or a four-step RACH procedure, and the RACH procedure may be associated with a RACH configuration. The RACH configuration may include information associated with performing the RACH procedure, such as an indication of a RACH preamble, (e.g., PRACH preamble), one or more resources associated with transmitting the RACH preamble, or the like thereof. Alternatively, the UE 115 may trigger (e.g., initiate, perform) the RACH procedure based on receiving a control message 215 indicating the RACH configuration.

In some examples (e.g., for inter-cell), a TRP 205 may transmit a control message 215 including an order (e.g., PDCCH order) indicating a RACH configuration associated with a PCI and the UE 115-a may determine a TAG associated with the TRP 205 based on the TAG being associated with the PCI. In another example (e.g., for intra-cell, applicable to contention free random access (CFRA) triggered by the PDCCH order), the control message 215 including the order (e.g., PDCCH order) may indicate the TAG (e.g., one of two TAGs) associated with the TRP 205 (e.g., to be used for a CC). In another example (e.g., for intra-cell, applicable to CFRA triggered by the PDCCH order), the control message 215 including the order may be associated with a CORESET pool index 225 and the UE 115-a may determine the TAG associated with the TRP 205 based on the TAG being associated with the CORESET pool index 225 of the order.

Alternatively (e.g., for intra-cell, applicable to contention based random access (CBRA), or UE 115 initiated, and CFRA, or TRP 205 triggered), the TRP 205 may indicate the TAG associated with the TRP 205 via one or more reserved bits in a RAR message or an absolute TA command during the RACH procedure (e.g., absolute TA command MAC-control element (MAC-CE)).

However, due to the multiple methods for indicating the TAG, such as via the RACH configuration or via the RAR message or absolute TA command, conflicts may exist between indicated TAGs. For example, some methods for indicating a TAG may be associated with the UE 115-a operating in the intra-cell mode while other methods may be associated with the UE 115-a operating in the inter-cell mode. As such, conflicts may exist between a current operational mode of the UE 115-a and a method in which a TAG is indicated to a UE 115-a.

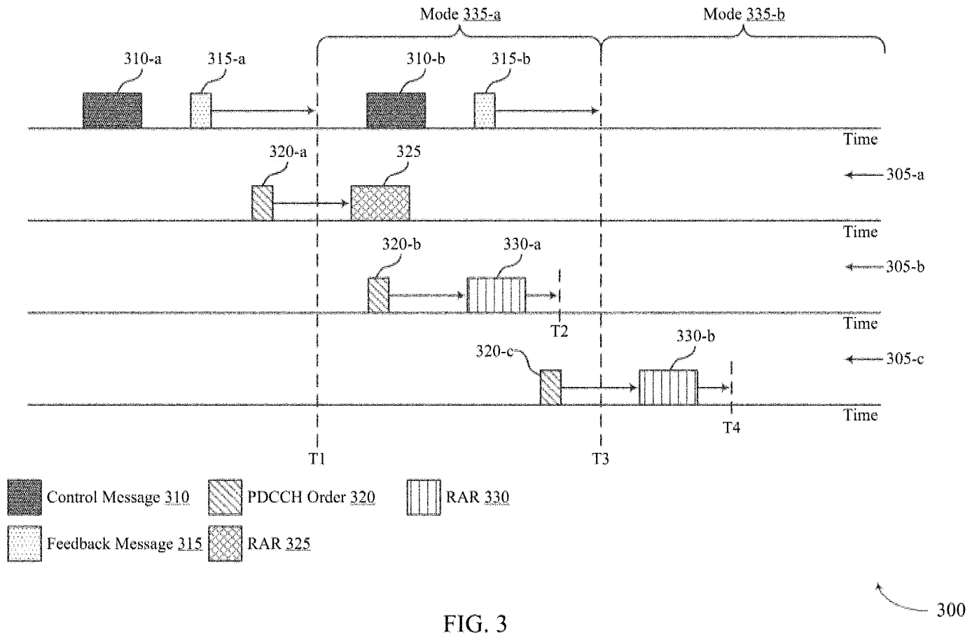

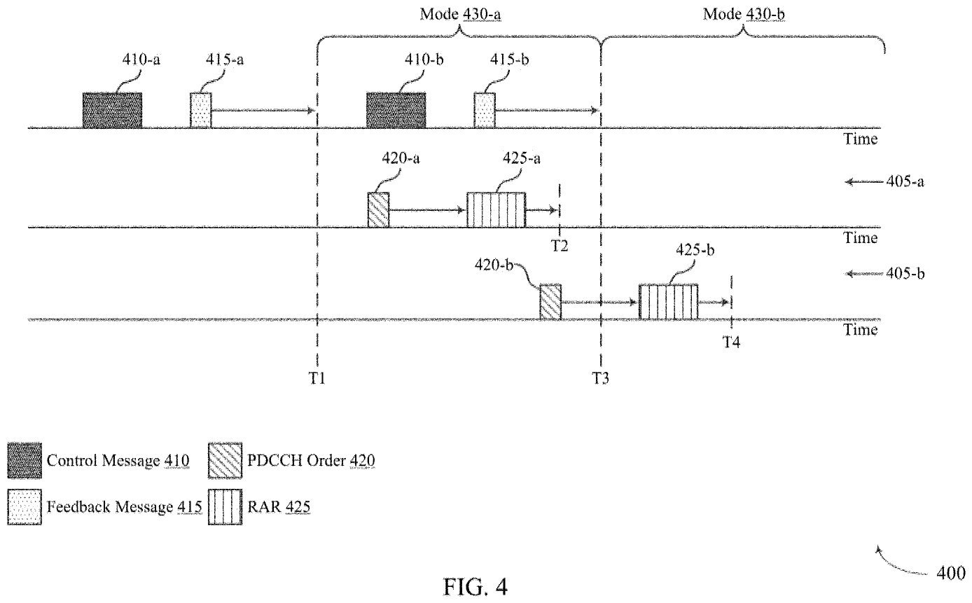

Accordingly, techniques described herein support an indication of one or more rules associated with interpreting one or more messages received by the UE 115-a to determine an TAG associated with a given TRP 205 (e.g., based on the UE 115-a supporting dynamic switching between the inter-cell mode and the intra-cell mode). In some examples, a rule may indicate whether the UE 115-a may use or ignore a TAG indication via one or more reserved bits in a RAR message, as described with reference to FIGS. 3 and 4. That is, in an inter-cell TRP scenario, a TRP 205 may indicate a TAG via a PCI-associated RACH configuration rather than the one or more reserved bits, such that the UE 115-a may ignore a TAG indication in the one or more reserved bits. Alternatively, in an intra-cell TRP scenario, a TRP 205 may indicate a TAG in the one or more reserved bits, such that the UE 115-a may use a TAG indication in the one or more reserved bits. As such, a rule may indicate for the UE 115-a to determine whether to apply or ignore the one or more reserved bits. For example, if a RAR message or absolute TA command associated with a RACH procedure is associated with an additional cell, the UE 115-a may ignore the one or more reserved bits, as described with reference to FIG. 3. Alternatively, if the RAR message or the absolute TA command associated with the RACH procedure is associated with a serving cell or the RACH procedure is initiated by the UE 115-a, the UE 115-a may use the one or more reserved bits in the RAR message or absolute TA command to determine a respective TAG, as described with reference to FIG. 3. In some other examples, the rule may indicate for the UE 115-a to determine whether to apply or ignore the one or more reserved bits based on an operational mode of the UE 115-a (e.g., intra-cell mode or inter-cell mode), as described with reference to FIG. 4.

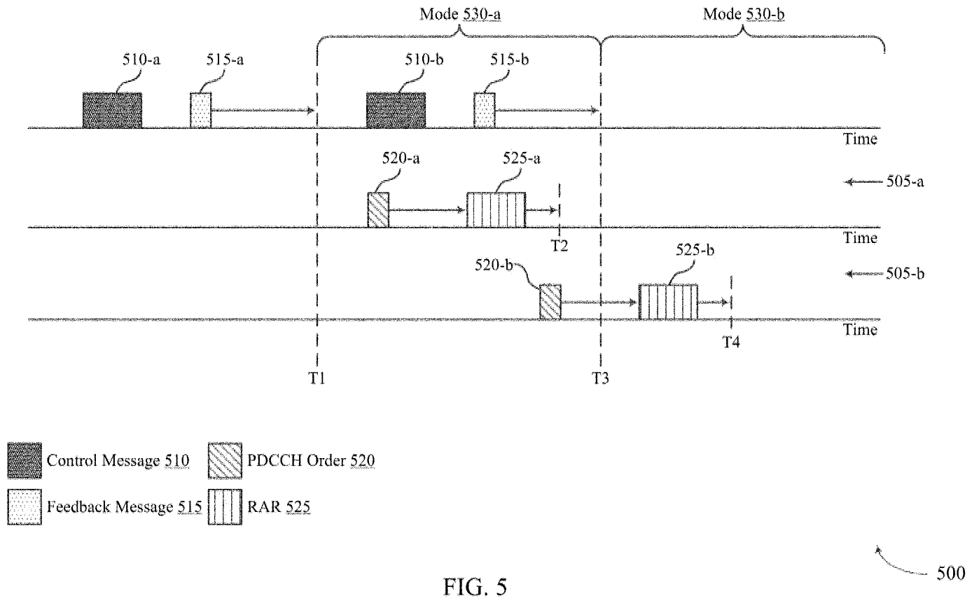

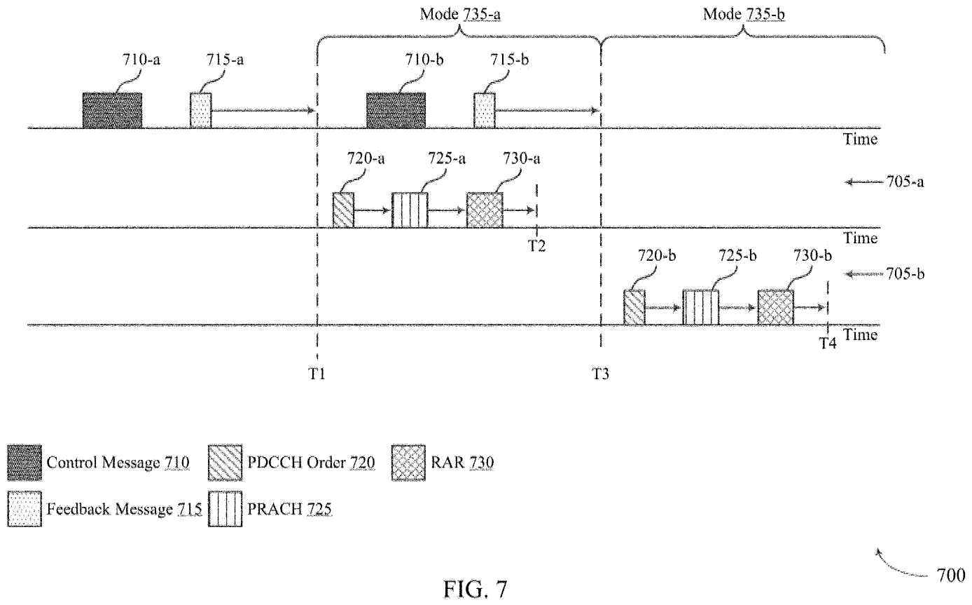

Additionally, or alternatively, the UE 115-a may receive a control message 215 including an order (e.g., PDCCH order) to initiate a RACH procedure and the order may indicate a state associated with a PCI, or may directly indicate a TAG, as described with reference to FIGS. 5 through 8. As such, the UE 115-a may apply the indicated state based on an operational mode of the UE 115-a (e.g., intra-cell mode or inter-cell mode). In some examples, the control message 215 may indicate the operational mode in addition to the indicated state, as described with reference to FIG. 7.

In some examples, the UE 115-a may receive a control message 215 indicating the one or more rules associated with interpreting one or more messages received by the UE 115-a. In other words, the UE 115-a may be configured with the one or more rules associated with interpreting one or more messages received by the UE 115-a.

FIG. 3 illustrates an example of a timing diagram 300 that supports PRACH enhancements for dynamic switching between inter-cell and intra-cell multi-TRPs in accordance with one or more aspects of the present disclosure. In some examples, may implement or be implemented by aspects of the wireless communications system 100 and the wireless communications system 200. For example, the timing diagram 300 may be implemented by one or more network entities 105 and one or more UEs 115, which may be examples of the corresponding devices as described with reference to FIG. 1. In some examples, a UE 115 may implement a rule associated with applying one or more reserved bits in a RAR message or absolute TA command received by the UE 115 to determine a TAG associated with a network entity 105 from a set of network entities 105 (e.g., TRPs).

A UE 115 may receive a control message 310 indicating a set of TAGs, where a first TAG (e.g., TAG1) from the set of TAGs is associated with a first CORESET pool index (e.g., CORESETPoolIndex=0) and a second TAG (e.g., TAG2) from the set of TAGs is associated with a second CORESET pool index (e.g., CORESETPoolIndex=1). As illustrated in the timing diagram 300, the UE 115 may receive a control message 310 (e.g., MAC CE) to activate one or more TCI states associated with serving cell PCI for the first CORESET pool index. That is, the first CORESET pool index may be associated with a serving PCI. In some examples, as illustrated in the timing diagram 300, the UE 115 may receive, in response to an initial uplink message of a random access procedure (e.g., PRACH preamble), a first downlink message of the first random access procedure. The downlink message may be a RAR message, such as a RAR 325, a RAR 330-a, or a RAR 330-b, or an absolute TA command (e.g., absolute TA command MAC-CE). For illustrative purposes, the RAR 325, the RAR 330-a, and the RAR 330-b may be used in the context of the timing diagram 300, however, it is understood that the RAR 325, the RAR 330-a, the RAR 330-b, or any combination thereof, may instead be absolute TA commands.

Additionally, the RAR 325, the RAR 330-a, and the RAR 330-b, or any combination thereof, may include one or more reserved bits that indicate one of the first TAG or the second TAG. As such, the UE 115 may select one of the first TAG of the second TAG based on a rule for application of the one or more reserved bits and may communicate in accordance with the selected TAG based on the selection.

In some examples, the rule for application of the one or more reserved bits may be based on a random access procedure being associated with the serving PCI or an additional PCI. That is, the UE 115 may receive a second downlink message including an order, which may be referred to as a PDCCH order 320, that triggers the random access procedure with the serving PCI or an additional PCI (e.g., that is different than the serving PCI). As such, the UE may determine to apply or ignore the one or more reserved bits based on the random access procedure being associated with the serving cell PCI or an additional PCI based on the PDCCH order 320.

In some examples, the rule for application of the one or more reserved bits may be indicative that the UE 115 is to ignore the one or more reserved bits based on the random access procedure being associated with an additional PCI. For example, as depicted in scenario 305-a, the UE 115 may receive a PDCCH order 320-a triggering a random access procedure (e.g., CFRA procedure) associated with an additional PCI. Additionally, the UE may transmit an uplink message (e.g., RACH preamble) of the random access procedure based on receiving the PDCCH order 320-a and may receive a RAR 325 (e.g., RAR 325 in response to the CFRA procedure associated with the additional PCI) in response to the uplink message. The RAR 325 may include one or more reserved bits indicating the first TAG or the second TAG and the UE may determine to ignore the one or more reserved bits based on the PDCCH order 320-a triggering the random access procedure being associated with the additional PCI. In such cases, the UE may select the first TAG or the second TAG based on a configuration (e.g., RACH configuration) associated with the additional PCI.

Additionally, or alternatively, the rule for application of the one or more reserved bits may be indicative that the rule for application of the one or more reserved bits may be indicative that the UE 115 is to apply (e.g., use) the one or more reserved bits based on the random access procedure being associated with the serving PCI. That is, the UE 115 may receive a PDCCH order 320, such as a PDCCH order 320-b or the PDCCH order 320-c, triggering a random access procedure (e.g., CFRA procedure) associated with the serving PCI or may initiate the random access procedure (e.g., CBRA procedure) associated with the serving PCI. Additionally, the UE 115 may receive a RAR 330 associated with the random access procedure (e.g., in response to the CFRA procedure associated with the serving PCI triggered by the PDCCH order 320 or in response to the UE 115 initiated CBRA procedure). The RAR 330 may include one or more reserved bits indicating the first TAG or the second TAG and the UE 115 may determine to apply (e.g., use) the one or more reserved bits based on the PDCCH order 320 triggering the random access procedure being associated with the serving PCI or based on the UE 115 initiating the random access procedure.

For example, as depicted in scenario 305-b, the UE 115 may receive a PDCCH order 320-b triggering a random access procedure (e.g., CFRA procedure) associated with the serving PCI. Additionally, the UE may transmit an uplink message (e.g., RACH preamble) of the random access procedure based on receiving the PDCCH order 320-b and may receive a RAR 330-a (e.g., RAR 330 in response to the CFRA procedure associated with the serving PCI) in response to the uplink message. The RAR 330-a may include one or more reserved bits indicating the first TAG or the second TAG and the UE 115 may determine to apply the one or more reserved bits based on the PDCCH order 320-b triggering the random access procedure being associated with the serving PCI. In other words, the UE 115 may select the first TAG or the second TAG based on the one or more reserved bits in the RAR 330-a.

In some examples, the TAG (e.g., TAG2) indicated in the one or more reserved bits may be associated with a CORESET pool index (e.g., CORESETPoolIndex=1) for which one or more active TCI states are associated with an additional cell of additional PCIs, which may be indicative that the UE 115 is operating in a mode 335-a, which may be an inter-cell mode 335. In such cases, the UE 115 may delay communicating in accordance with the indicated TAG (e.g., selected TAG) based on the UE 115 operating in the mode 335-a at a time that the RAR 330 is received or to be applied.

For example, the UE 115 may receive a control message 310-a activating one or more TCI states associated with an additional cell for the second CORESET pool index. As such, the UE 115 may activate the one or more TCI states associated with the additional cell at a time T1 after transmitting a feedback message 315-a (e.g., acknowledgement message) in response to the control message 310-a. In such cases, the UE 115 may operate in the mode 335-a based on activation of the one or more TCI states associated with the additional PCI (e.g., at T1). Additionally, as depicted in a scenario 305-b, the UE 115 may receive a PDCCH order 320-b triggering a random access procedure associated with a serving PCI and may receive a RAR 330-a (e.g., of the random access procedure) indicating a TAG (e.g., TAG2) associated with the one or more TCI states associated with the additional cell (e.g., CORESETPoolIndex=1). As such, the UE 115 may delay communicating in accordance with the indicated TAG (e.g., selected TAG) based on the UE 115 operating in the mode 335-a at a time that the RAR 330-a is received or to be applied, at a time T2 (e.g., based on the second CORESET pool index being associated with the additional PCI, based on the one or more TCI states for the second CORESET pool index being associated with the additional PCI).

Continuing with the scenario 305-b, the UE 115 may receive a control message 310-b activating the one or more TCI states associated with the serving PCI for the second CORESET pool index. That is, the control message 310-b may switch the active PCI for the second CORESET pool index from additional PCI to serving cell PCI. In other words, the control message 310-b may activate the second CORESET pool index with a serving PCI (e.g., the serving cell PCI may be activated for the CORESETPoolIndex=1), such that the one or more activated TCI states (e.g., previously associated with the additional PCI) are associated with the serving PCI. As such, the UE 115 may activate the serving cell for the second CORESET pool index (e.g., may associate the CORESET pool index 1 with the serving PCI) at a time T3 after transmitting a feedback message 315-b (e.g., acknowledgement message) in response to the control message 310-b. In other words, the UE 115 may operate in the mode 335-b, which may be an intra-cell mode 335, based on activating the serving PCI for the second CORESET pool index (e.g., based on associating the one or more TCI states with the serving PCI). As such, the UE 115 may communicate in accordance with the TAG indicated via the RAR 330-a (e.g., at the time T3) based on activation of the serving cell for the second CORESET pool index.

In another example, as depicted in scenario 305-c, the UE 115 may receive a PDCCH order 320-c triggering a random access procedure associated with a serving PCI and may receive a RAR 330-b (e.g., of the random access procedure) indicating a TAG (e.g., TAG2) associated with the second CORESET pool index (e.g., CORESETPoolIndex=1) for which the one or more TCI states are associated with the serving cell PCI. As such, the UE 115 may communicate in accordance with (e.g., apply) the indicated TAG based on the UE 115 operating in the mode 335-b at a time T4 that the RAR 330-b is applied. In other words, the UE 115 may communicate in accordance with the indicated TAG (e.g., TAG2) based on the second CORESET pool index (e.g., CORESETPoolIndex=1) being activated as the serving cell (e.g., being associated with a serving PCI) at a time T3 prior to application of the indicated TAG at a time T4. In some examples, a time between receipt of a RAR 330 and application of a TAG indicated in the RAR 330 may be referred to as a TA application time. Further, application of a TAG may refer to application of a TA associated with the TAG or communicating (e.g., beginning to communicate) using a TA associated with the TAG.

FIG. 4 illustrates an example of a timing diagram 400 that supports PRACH enhancements for dynamic switching between inter-cell and intra-cell multi-TRPs in accordance with one or more aspects of the present disclosure. In some examples, the timing diagram 400 may implement or be implemented by aspects of the wireless communications system 100, the wireless communications system 200, and the timing diagram 300. For example, the timing diagram 400 may be implemented by one or more network entities 105 and one or more UEs 115, which may be examples of the corresponding devices as described with reference to FIG. 1. In some examples, a UE 115 may implement a rule associated with applying one or more reserved bits in a RAR message or absolute TA command received by the UE 115 to determine a TAG associated with a network entity 105 from a set of network entities 105 (e.g., TRPs).

A UE 115 may receive a control message 410 indicating a set of TAGs, where a first TAG (e.g., TAG1) from the set of TAGs is associated with a first CORESET pool index (e.g., CORESETPoolIndex=0) and a second TAG (e.g., TAG2) from the set of TAGs is associated with a second CORESET pool index (e.g., CORESETPoolIndex=1). As illustrated in the timing diagram 400, the UE 115 may receive a control message 410 (e.g., MAC CE) to activate one or more TCI states associated with serving cell PCI for the first CORESET pool index. That is, the first CORESET pool index may be associated with a serving PCI. In some examples, as illustrated in the timing diagram 400, the UE 115 may receive, in response to an initial uplink message of a random access procedure (e.g., PRACH preamble), a first downlink message of the first random access procedure. The first downlink message may be a RAR message, such as a RAR 425, or an absolute TA command (e.g., absolute TA command MAC-CE). For illustrative purposes, RARs 425 may be used in the context of the timing diagram 400, however, it is understood that the RARs 425 may instead be absolute TA commands.

Additionally, the RAR 425 may include one or more reserved bits that indicate one of the first TAG or the second TAG. As such, the UE 115 may select one of the first TAG of the second TAG based on a rule for application of the one or more reserved bits and may communicate in accordance with the selected TAG based on the selection. In some examples, the rule for application of the one or more reserved bits may be based on a mode 430 (e.g., multi-TRP communication mode 430) of the UE 115 at a time that the RAR 425 is received or is to be applied.

In some examples, the rule for application of the one or more reserved bits may be indicative that the UE 115 is to ignore the one or more reserved bits based on the UE 115 operating in a mode 430-a, which may be an inter-cell mode 430, at the time that the RAR 425 is received or is to be applied. For example, the UE 115 may receive a control message 410-a activating one or more TCI states associated with an additional cell for the second CORESET pool index (e.g., CORESET pool index 1). As such, the UE 115 may activate the one or more TCI states associated with the additional cell at a time T1 after transmitting a feedback message 415-a (e.g., acknowledgement message) in response to the control message 410-a. In such cases, the UE 115 may operate in the mode 430-a based on activation of the one or more TCI states associated with the additional PCI (e.g., at T1). Additionally, as depicted in a scenario 405-a, the UE 115 may receive a PDCCH order 420-a triggering a random access procedure associated with a serving PCI and may receive a RAR 425-a (e.g., of the random access procedure) including one or more reserved bits indicating a TAG. As such, the UE 115 may ignore the one or more reserved bits in the RAR 425-a based on the UE 115 operating in the mode 430-a at a time that the RAR 425-a is received or is to be applied, at a time T2.

Additionally, or alternatively, the rule for application of the one or more reserved bits may be indicative that the UE 115 is to apply (e.g., use) the one or more reserved bits based on the UE 115 operating in a mode 430-b, which may be an intra-cell mode 430, at the time that the RAR 425 is received or is to be applied. For example, the UE 115 may receive a control message 410-b activating a serving cell for the second CORESET pool index (e.g., activated TCI states associated with a serving PCI for CORESET pool index 1). As such, the UE 115 may switch the active PCI for the second CORESET pool index from an additional PCI to the serving cell PCI (e.g., activate the serving PCI for the one or more activated TCI states) at a time T3 after transmitting a feedback message 415-b (e.g., acknowledgement message) in response to the control message 410-b. In such cases, the UE 115 may operate in the mode 430-b based on activation the serving cell for the second CORESET pool index (e.g., at the time T3). Additionally, as depicted in a scenario 405-b, the UE 115 may receive a PDCCH order 420-b triggering a random access procedure associated with a serving PCI and may receive a RAR 425-b (e.g., of the random access procedure) including one or more reserved bits indicating a TAG. As such, the UE 115 may apply the one or more reserved bits in the RAR 425-b based on the UE 115 operating in the mode 430-b at a time that the RAR 425-b is received or is to be applied, at a time T4. In other words, the UE 115 may communicate using a TA associated with the TAG indicated in the RAR 425-b at the time T4.

FIG. 5 illustrates an example of a timing diagram 500 that supports PRACH enhancements for dynamic switching between inter-cell and intra-cell multi-TRPs in accordance with one or more aspects of the present disclosure. In some examples, the timing diagram 500 may implement or be implemented by aspects of the wireless communications system 100, the wireless communications system 200, the timing diagram 300, and the timing diagram 400. For example, the timing diagram 500 may be implemented by one or more network entities 105 and one or more UEs 115, which may be examples of the corresponding devices as described with reference to FIG. 1. In some examples, a UE 115 may apply a state indicated via an order included in a control message based on an operational mode of the UE 115.

A UE 115 may receive a control message 510 indicating a set of TAGs, where a first TAG (e.g., TAG1) from the set of TAGs is associated with a first CORESET pool index (e.g., CORESETPoolIndex=0) and a second TAG (e.g., TAG2) from the set of TAGs is associated with a second CORESET pool index (e.g., CORESETPoolIndex=1). As illustrated in the timing diagram 500, the UE 115 may receive a control message 510 (e.g., MAC CE) to activate one or more TCI states associated with serving cell PCI for the first CORESET pool index. That is, the first CORESET pool index may be associated with a serving PCI. In some examples, as illustrated in the timing diagram 500, the UE 115 may receive a downlink message including an order, which may be referred to as a PDCCH order 520, triggering a random access procedure. The PDCCH order 520 may indicate a state from a set of states and each state may be associated with a PCI from a set of PCIs and may indicate a TAG that is to be used by the UE 115.

In some examples (e.g., dynamic switching between the mode 530-a and the mode 530-b is enable and two TAGs are enable for the mode 530-b), the set of states (e.g., including x+2 states, where x is a quantity of additional PCIs configured for the UE 115) may include a first state indicating the first TAG associated with the serving PCI from the set of PCIs (e.g., including the serving PCI and the additional PCIs), a second state indicating the second TAG associated with the serving PCI, and one or more third states each indicating for the UE 115 to transmit an uplink message of the random access procedure in accordance with a random access procedure configuration (e.g., PRACH configuration) associated with respective additional PCIs from the set of PCIs.

For example, the UE 115 may receive a control message 510 indicating (e.g., configuring) 2 additional PCIs, such as a first additional PCI and a second additional PCI. As such, the set of states may include the first state indicating the first TAG associated with the serving PCI from the set of PCIs, the second state indicating the second TAG associated with the serving PCI, a third state indicating for the UE 115 to transmit an uplink message of the random access procedure in accordance with a random access procedure configuration associated with the first additional PCIs from the set of PCIs, and a fourth state indicating for the UE 115 to transmit the uplink message of the random access procedure in accordance with a random access procedure configuration associated with the second additional PCIs from the set of PCIs. In some examples, the UE 115 may receive a control message 510 indicating the set of states (e.g., via RRC configuration).

As an illustrative example, as depicted in a scenario 505-a, the UE 115 may receive a PDCCH order 520-a triggering a random access procedure and indicating a state from the set of states. As such, the UE 115 may select a TAG from the first TAG, the second TAG based on the indicated state. Additionally, the UE 115 may transmit an uplink message (e.g., RACH preamble) of the random access procedure based on receiving the PDCCH order 520-a and may receive a RAR 525-a in response to the uplink message. Further, the UE 115 may communicate in accordance with the selected TAG (e.g., communicate using a TA associated with the selected TAG) at a time T2 after receipt of the RAR 525-a (e.g., after a TA application time).

In some examples, the TAG (e.g., TAG2) associated with the serving PCI indicated in the PDCCH order 520-a may be associated with one or more TCI states that are associated with an additional cell (e.g., CORESETPoolIndex=1) of additional PCIs, which may be indicative that the UE 115 is operating in a mode 530-a, which may be an inter-cell mode 530. In such cases, the UE 115 may delay communicating in accordance with the indicated TAG (e.g., selected TAG) based on the UE 115 operating in the mode 530-a at a time that the RAR 525-a is received or is to be applied.

For example, the UE 115 may receive a control message 510-a activating one or more TCI states associated with an additional cell for the second CORESET pool index value. As such, the UE 115 may activate the one or more TCI states associated with the additional cell for the second CORESET pool index at a time T1 after transmitting a feedback message 515-a (e.g., acknowledgement message) in response to the control message 510-a. In such cases, the UE 115 may operate in the mode 530-a based on activation of the one or more TCI states associated with the additional PCI (e.g., at T1). Additionally, as depicted in a scenario 505-a, the UE 115 may receive the PDCCH order 520-b triggering the random access procedure associated with a serving PCI and may receive the RAR 525-a (e.g., of the random access procedure) indicating a TAG (e.g., TAG2) associated the second CORESET pool index (e.g., CORESETPoolIndex=1). for which the one or more TCI states are associated with the additional cell As such, the UE 115 may delay communicating in accordance with the indicated TAG (e.g., selected TAG) based on the UE 115 operating in the mode 530-a at a time that the RAR 525-a is received or to be applied, at a time T2 (e.g., based on the second CORESET pool index being associated with the additional PCI, based on the one or more TCI states being associated with the additional PCI).

Continuing with the scenario 505-a, the UE 115 may receive a control message 510-b activating the one or more TCI states associated with the serving PCI for the second CORESET pool index. That is, the control message 510-b may activate the one or more TCI states associated with a serving cell for the second CORESET pool index. In other words, the control message 510-b may switch the active PCI for the second CORESET pool index from an additional PCI to the serving cell PCI (e.g., the serving cell PCI may be activated for the CORESETPoolIndex=1), such that the one or more activated TCI states (e.g., previously associated with the additional PCI) are associated with the serving PCI. As such, the UE 115 may activate the second CORESET pool index with the serving cell PCI (e.g., may associate the second CORESET pool index with the serving PCI) at a time T3 after transmitting a feedback message 515-b (e.g., acknowledgement message) in response to the control message 510-b. In other words, the UE 115 may operate in the mode 530-b, which may be an intra-cell mode 530, based on activating the serving PCI for the second CORESET pool index (e.g., based on associating the one or more TCI states with the serving PCI). As such, the UE 115 may communicate in accordance with the TAG indicated via the RAR 525-a (e.g., at the time T3) based on activation of the serving cell PCI for the second CORESET pool index.

In another example, as depicted in scenario 505-b, the UE 115 may receive a PDCCH order 520-b triggering a random access procedure associated with a serving PCI and may receive a RAR 525-b (e.g., of the random access procedure) indicating a TAG (e.g., TAG2) associated with the second CORESET pool index (e.g., CORESETPoolIndex=1) for which the one or more TCI states are associated with the additional cell. As such, the UE 115 may communicate in accordance with (e.g., apply) the indicated TAG based on the UE 115 operating in the mode 530-b at a time T4 that the RAR 525-b is applied. In other words, the UE 115 may communicate in accordance with the indicated TAG (e.g., TAG2) based on the second CORESET pool index (e.g., CORESETPoolIndex=1) being activated as the serving cell (e.g., being associated with a serving PCI) at a time T3 prior to application of the indicated TAG at a time T4. In some examples, a time between receipt of a RAR 525 and application of a TAG indicated in the RAR 525 may be referred to as a TA application time. Further, application of a TAG may refer to application of a TA associated with the TAG or communicating (e.g., beginning to communicate) using a TA associated with the TAG.

In some examples (e.g., dynamic switching between the mode 530-a and the mode 530-b is disable or not enable and two TAGs are disable or not enabled for the mode 530-b), the set of states (e.g., including x+1 states, where x is a quantity of additional PCIs configured for the UE 115) may include a first state indicating for the UE 115 to transmit an uplink message of the random access procedure in accordance with a random access procedure configuration (e.g., PRACH configuration) associated with the serving PCI and one or more states each indicating for the UE 115 to transmit an uplink message of the random access procedure in accordance with a random access procedure configuration (e.g., PRACH configuration) associated with respective additional PCIs from the set of PCIs.

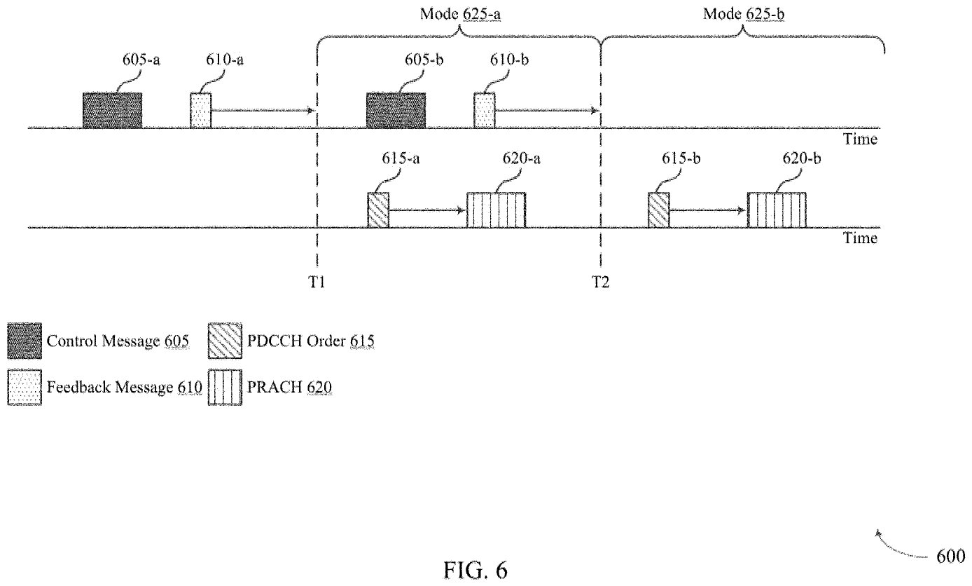

FIG. 6 illustrates an example of a timing diagram 600 that supports PRACH enhancements for dynamic switching between inter-cell and intra-cell multi-TRPs in accordance with one or more aspects of the present disclosure. In some examples, the timing diagram 600 may implement or be implemented by aspects of the wireless communications system 100, the wireless communications system 200, the timing diagram 300, the timing diagram 400, and the timing diagram 500. For example, the timing diagram 600 may be implemented by one or more network entities 105 and one or more UEs 115, which may be examples of the corresponding devices as described with reference to FIG. 1. In some examples, a UE 115 may apply a state indicated via an order included in a control message based on an operational mode of the UE 115.

A UE 115 may receive a control message 605 indicating a set of TAGs, where a first TAG (e.g., TAG1) from the set of TAGs is associated with a first CORESET pool index (e.g., CORESETPoolIndex=0) and a second TAG (e.g., TAG2) from the set of TAGs is associated with a second CORESET pool index (e.g., CORESETPoolIndex=1). As illustrated in the timing diagram 600, the UE 115 may receive a control message 610 (e.g., MAC CE) to activate one or more TCI states associated with serving cell PCI for the first CORESET pool index. That is, the first CORESET pool index may be associated with a serving PCI. In some examples, as illustrated in the timing diagram 600, the UE 115 may receive a downlink message including an order, which may be referred to as a PDCCH order 615, triggering a random access procedure. The PDCCH order 615 may indicate a state from a set of states and each state may be associated with a PCI from a set of PCIs and may indicate a TAG that is to be used by the UE 115.

In some examples, the set of states may be based on an mode 625 of the UE 115. For example, (e.g., for an inter-cell mode 625), the set of states (e.g., including x+1 states, where x is a quantity of additional PCIs configured for the UE 115) may include a first state indicating for the UE 115 to transmit an uplink message of the random access procedure in accordance with a random access procedure configuration (e.g., PRACH configuration) associated with the serving PCI and one or more states each indicating for the UE 115 to transmit an uplink message of the random access procedure in accordance with a random access procedure configuration (e.g., PRACH configuration) associated with respective additional PCIs from the set of PCIs based on the UE 115 operating in a mode 625-a, which may be an inter-cell mode 625.

For example, the UE 115 may receive a control message 605-a activating one or more TCI states associated with an additional cell for the second CORESET pool index. As such, the UE 115 may activate the one or more TCI states associated with the additional cell for the second CORESET pool index at a time T1 after transmitting a feedback message 610-a (e.g., acknowledgement message) in response to the control message 605-a. In such cases, the UE 115 may operate in the mode 625-a based on activation of the one or more TCI states associated with the additional PCI (e.g., at T1). Additionally, the UE 115 may receive a PDCCH order 615-a triggering a random access procedure and indicating a state from the set of states, where the set of states is based on the UE 115 operating in the mode 625-a. As such, the UE 115 may select a TAG from the first TAG or the second TAG based on the indicated state. Additionally, the UE 115 may transmit an uplink message, such as a PRACH 620-a (e.g., in response to the PDCCH order 615-a), in accordance with the selected TAG.

In another example (e.g., for an intra-cell mode 625), the set of states (e.g., including 2 states) may include a first state indicating the first TAG associated with a serving PCI from the set of PCIs (e.g., including the serving PCI and the additional PCIs), a second state indicating the second TAG associated with the serving PCI based on the UE 115 operating in a mode 625-b, which may be an intra-cell mode 625.

For example, the UE 115 may receive a control message 605-b activating one or more TCI states associated with an serving cell for the second CORESET pool index. As such, the UE 115 may activate the one or more TCI states associated with the serving cell for the second CORESET pool index at a time T2 after transmitting a feedback message 610-b (e.g., acknowledgement message) in response to the control message 605-b. In such cases, the UE 115 may operate in the mode 625-b based on activation of the one or more TCI states associated with the serving PCI (e.g., at T2). Additionally, the UE 115 may receive a PDCCH order 615-b triggering a random access procedure and indicating a state from the set of states, where the set of states is based on the UE 115 operating in the mode 625-b. As such, the UE 115 may select a TAG from the first TAG or the second TAG based on the indicated state. Additionally, the UE 115 may transmit an uplink message, such as a PRACH 620-b (e.g., in response to the PDCCH order 615-b), in accordance with the selected TAG.

In some examples, a mode 625 of the UE 115 may be determined (e.g., by the UE 115, a network entity 105, or both) based on a mode 625 of the UE 115 at a time associated with receiving a PDCCH order 615 or at a time associated with transmitting a PRACH 620. For example, the UE 115 may operate in the mode 625-a at a time associated with receiving the PDCCH order 615-a and at a time associated with transmitting the PRACH 620-a. Similarly, the UE 115 may operate in the mode 625-b at a time associated with receiving the PDCCH order 615-b and at a time associated with transmitting the PRACH 620-b.

FIG. 7 illustrates an example of a timing diagram 700 that supports PRACH enhancements for dynamic switching between inter-cell and intra-cell multi-TRPs in accordance with one or more aspects of the present disclosure. In some examples, the timing diagram 700 may implement or be implemented by aspects of the wireless communications system 100, the wireless communications system 200, the timing diagram 300, the timing diagram 400, the timing diagram 500, and the timing diagram 600. For example, the timing diagram 700 may be implemented by one or more network entities 105 and one or more UEs 115, which may be examples of the corresponding devices as described with reference to FIG. 1. In some examples, a UE 115 may apply a state indicated via an order included in a control message based on an operational mode of the UE 115.

A UE 115 may receive a control message 710 indicating a set of TAGs, where a first TAG (e.g., TAG1) from the set of TAGs is associated with a first CORESET pool index (e.g., CORESETPoolIndex=0) and a second TAG (e.g., TAG2) from the set of TAGs is associated with a second CORESET pool index (e.g., CORESETPoolIndex=1). As illustrated in the timing diagram 700, the UE 115 may receive a control message 710 (e.g., MAC CE) to activate one or more TCI states associated with serving cell PCI for the first CORESET pool index. That is, the first CORESET pool index may be associated with a serving PCI. In some examples, as illustrated in the timing diagram 700, the UE 115 may receive a downlink message including an order, which may be referred to as a PDCCH order 720, triggering a random access procedure. The PDCCH order 720 may indicate a state from a set of states and each state may be associated with a PCI from a set of PCIs and may indicate a TAG that is to be used by the UE 115.

In some examples, the set of states (e.g., including x+2 states, where x is a quantity of additional PCIs configured for the UE 115) may include a first state indicating the random access procedure is associated with an intra-cell mode 735, a second state indicating for the UE 115 to transmit the uplink message in accordance with a first random access procedure configuration (e.g., PRACH configuration) associated with a serving PCI from the set of PCIs, and one or more third states each indicating for the UE 115 to transmit the uplink message in accordance with a random access procedure configuration associated with respective additional PCIs from the set of PCIs.

As an illustrative example, as depicted in a scenario 705-a, the UE 115 may receive a PDCCH order 720-a triggering a random access procedure and indicating a state from the set of states. As such, the UE 115 may select a TAG from the first TAG or the second TAG based on the indicated state. Additionally, the UE 115 may transmit an uplink message (e.g., RACH preamble), such as a PRACH 725-a, of the random access procedure based on receiving the PDCCH order 720-a and may receive a RAR 730-a in response to the PRACH 725-a. Further, the UE 115 may communicate in accordance with the selected TAG (e.g., communicate using a TA associated with the selected TAG) at a time T2 after receipt of the RAR 730-a (e.g., after a TA application time).

In some cases (e.g., the PRACH 725-a is associated with the mode 735-b), the UE may select the first TAG or the second TAG based on a CORESET pool index (e.g., CORESET pool index value) associated with the PDCCH order 720-a. In some examples, the TAG (e.g., TAG2) associated with (e.g., determined based on the CORESET pool index associated with) the PDCCH order 520-a may be associated with one or more TCI states that are associated with an additional PCI, which may be indicative that the UE 115 is operating in a mode 735-a. In such cases, the UE 115 may delay communicating in accordance with the indicated TAG (e.g., selected TAG) based on the UE 115 operating in the mode 735-a at a time that the RAR 730-a is received or is to be applied (e.g., at the time T2).

For example, the UE 115 may receive a control message 710-a activating one or more TCI states associated with an additional cell for the second CORESET pool index. As such, the UE 115 may activate the one or more TCI states associated with the additional cell for the second CORESET pool index at a time T1 after transmitting a feedback message 715-a (e.g., acknowledgement message) in response to the control message 710-a. In such cases, the UE 115 may operate in the mode 735-a based on activation of the one or more TCI states associated with the additional PCI (e.g., at T1). Additionally, as depicted in a scenario 705-a, the UE 115 may receive the PDCCH order 720-a triggering the random access procedure associated with a serving PCI and indicating the PRACH procedure is associated with intra-cell mode 735-b and may receive the RAR 730-a (e.g., of the random access procedure) indicating a TAG (e.g., TAG2) associated with the second CORESET pool index (e.g., CORESETPoolIndex=1) for which the one or more TCI states are associated with the additional cell. As such, the UE 115 may delay communicating in accordance with the indicated TAG (e.g., selected TAG) based on the UE 115 operating in the mode 735-a at a time that the RAR 730-a is received or to be applied, at the time T2 (e.g., based on the additional cell being associated with the additional PCI, based on the one or more TCI states being associated with the additional PCI).

Continuing with the scenario 705-a, the UE 115 may receive a control message 710-b activating the one or more TCI states associated with the serving PCI for the second CORESET pool index. That is, the control message 710-b may activate the one or more TCI states associated with a serving cell for the second CORESET pool index. In other words, the control message 710-b may switch the active PCI for the second CORESET pool index from an additional PCI to the serving cell PCI (e.g., the serving cell PCI may be activated for the CORESETPoolIndex=1), such that the one or more activated TCI states (e.g., previously associated with the additional PCI) are associated with the serving PCI. As such, the UE 115 may activate the serving cell for the second CORESET pool index (e.g., may associate the second CORESET pool index with the serving PCI) at a time T3 after transmitting a feedback message 715-b (e.g., acknowledgement message) in response to the control message 710-b. In other words, the UE 115 may operate in the mode 735-b based on activating the serving PCI for the second CORESET pool index (e.g., based on associating the one or more TCI states with the serving PCI). As such, the UE 115 may communicate in accordance with the TAG indicated via the RAR 730-a (e.g., at the time T3) based on activation of the additional cell as the serving cell.

In another example, as depicted in scenario 705-b, the UE 115 may receive a PDCCH order 720-b triggering a random access procedure associated with a serving PCI and indicating a state from the set of states. As such, the UE 115 may select a TAG from the first TAG, the second TAG based on the indicated state. Additionally, the UE 115 may transmit an uplink message (e.g., RACH preamble), such as a PRACH 725-b, of the random access procedure based on receiving the PDCCH order 720-b and may receive a RAR 730-b in response to the PRACH 725-b. In such cases, the TA in RAR 730-b (e.g., of the random access procedure) may be associated with the second CORESET pool index based on the CORESET pool index value of the PDCCH order 720-b. As such, the UE 115 may communicate in accordance with (e.g., apply) the indicated TAG based on the UE 115 operating in the mode 735-b at a time T4 that the RAR 730-b is applied. In other words, the UE 115 may communicate in accordance with the indicated TAG (e.g., TAG2) based on the second CORESET pool index (e.g., CORESETPoolIndex=1) being activated as the serving cell (e.g., being associated with a serving PCI) at a time T3 prior to application of the indicated TAG at a time T4. In some examples, a time between receipt of a RAR 730 and application of a TAG indicated in the RAR 730 may be referred to as a TA application time. Further, application of a TAG may refer to application of a TA associated with the TAG or communicating (e.g., beginning to communicate) using a TA associated with the TAG.

In some cases (e.g., a PRACH 725 is associated with the mode 735-a), the UE may select the first TAG or the second TAG based on an indication in a PDCCH order 720 (e.g., and ignore a CORESET pool index value associated with the PDCCH order 720).

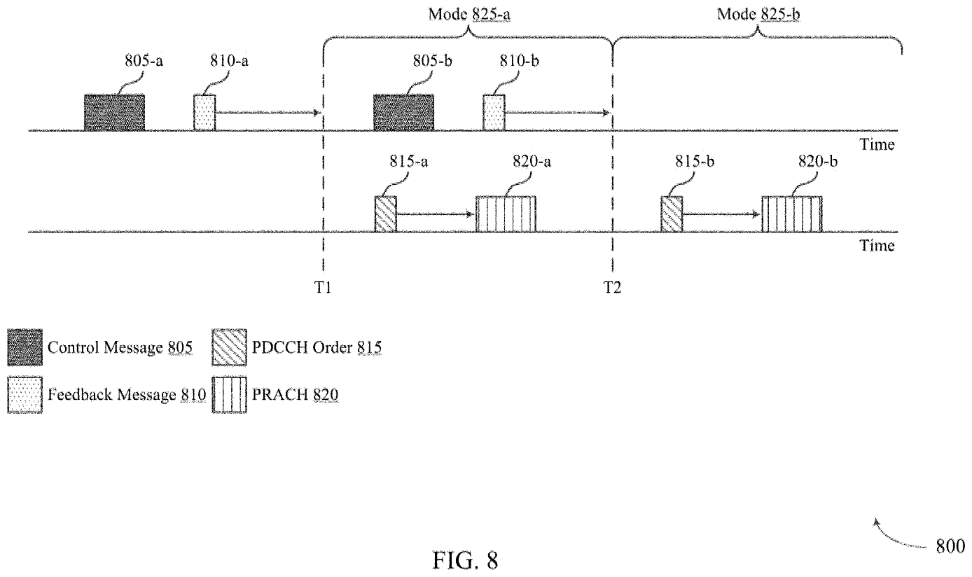

FIG. 8 illustrates an example of a timing diagram 800 that supports PRACH enhancements for dynamic switching between inter-cell and intra-cell multi-TRPs in accordance with one or more aspects of the present disclosure. In some examples, the timing diagram 800 may implement or be implemented by aspects of the wireless communications system 100, the wireless communications system 200, the timing diagram 300, the timing diagram 400, the timing diagram 500, the timing diagram 600, and the timing diagram 700. For example, the timing diagram 800 may be implemented by one or more network entities 105 and one or more UEs 115, which may be examples of the corresponding devices as described with reference to FIG. 1. In some examples, a UE 115 may apply a state indicated via an order included in a control message based on an operational mode of the UE 115.

A UE 115 may receive a control message 805 indicating a set of TAGs, where a first TAG (e.g., TAG1) from the set of TAGs is associated with a first CORESET (e.g., CORESETPoolIndex=0) and a second TAG (e.g., TAG2) from the set of TAGs is associated with a second CORESET (e.g., CORESETPoolIndex=1). In some examples, as illustrated in the timing diagram 800, the UE 115 may receive a downlink message triggering a random access procedure. The downlink message may include an order, which may be referred to as a PDCCH order 815, indicating a state from a set of states. Each state may be associated with a PCI from a set of PCIs and may indicate a TAG that is to be used by the UE 115.

In some examples, the set of states (e.g., including x+1 states, where x is a quantity of additional PCIs configured for the UE 115) may include a first state indicating for the UE 115 to transmit an uplink message of the random access procedure in accordance with a random access procedure configuration (e.g., PRACH configuration) associated with the serving PCI and one or more states each indicating for the UE 115 to transmit an uplink message of the random access procedure in accordance with a random access procedure configuration (e.g., PRACH configuration) associated with respective additional PCIs from the set of PCIs. Additionally, the UE 115 may determine whether to use a value of a CORESET pool index associated with a PDCCH order 815 to select the first TAG or the second TAG or to use the indicated state based on a mode 825 of the UE 115.

For example, the UE 115 may receive a control message 805-a activating one or more TCI states associated with an additional cell for the second CORESET pool index. As such, the UE 115 may activate the one or more TCI states associated with the additional cell for the second CORESET pool index at a time T1 after transmitting a feedback message 810-a (e.g., acknowledgement message) in response to the control message 805-a. In such cases, the UE 115 may operate in the mode 825-a, which may be an inter-cell mode 825, based on activation of the one or more TCI states associated with the additional PCI (e.g., at T1). Additionally, the UE 115 may receive a PDCCH order 815-a triggering a random access procedure and indicating a state from the set of states (e.g., where the set of states is based on the UE 115 operating in the mode 825-a). As such, the UE 115 may select a TAG from the first TAG or the second TAG based on the indicated state (e.g., and based on the UE 115 operating in the mode 825-a).

In another example, the UE 115 may receive a control message 805-b activating one or more TCI states associated with a serving cell for the second CORESET pool index. As such, the UE 115 may activate the one or more TCI states associated with the serving cell at a time T2 for the second CORESET pool index after transmitting a feedback message 810-b (e.g., acknowledgement message) in response to the control message 805-b. In such cases, the UE 115 may operate in the mode 825-b, which may be an intra-cell mode 825, based on activation of the one or more TCI states associated with the serving PCI (e.g., at T2). Additionally, the UE 115 may receive a PDCCH order 815-b triggering a random access procedure where the PDCCH order is received in the mode 825-b or the random access preamble is transmitted in the mode 825-b. As such, the UE 115 may select a TAG from the first TAG or the second TAG based on a value of a CORESET pool index associated with the PDCCH order 815-b (e.g., and based on the UE 115 operating in the mode 825-b).

In some examples, a mode 825 of the UE 115 may be determined (e.g., by the UE 115, a network entity 105, or both) based on a mode 825 of the UE 115 at a time associated with receiving a PDCCH order 815 or at a time associated with transmitting a PRACH 820. For example, the UE 115 may operate in the mode 825-a at a time associated with receiving the PDCCH order 815-a and at a time associated with transmitting a PRACH 820-a. Similarly, the UE 115 may operate in the mode 825-b at a time associated with receiving the PDCCH order 815-b and at a time associated with transmitting a PRACH 820-b.

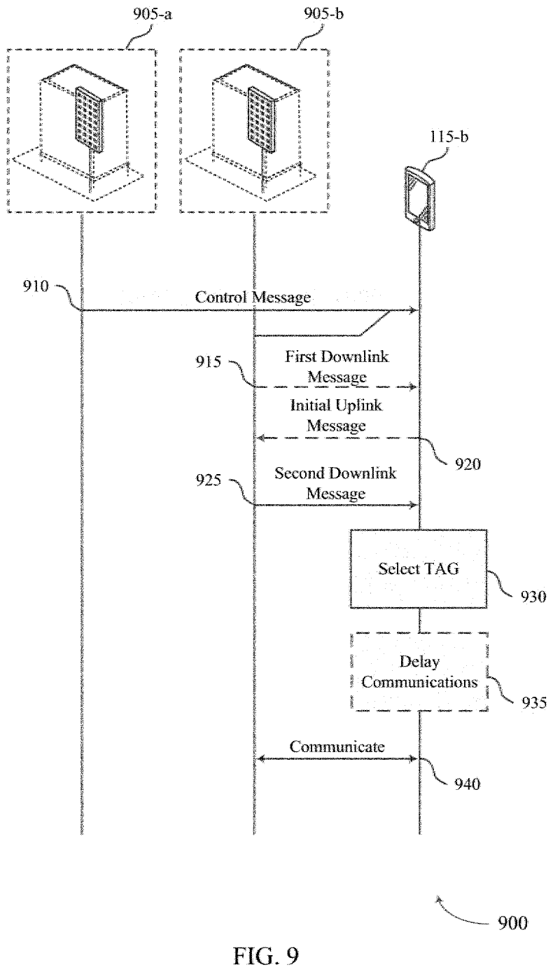

FIG. 9 illustrates an example of a process flow 900 that supports PRACH enhancements for dynamic switching between inter-cell and intra-cell multi-TRPs in accordance with one or more aspects of the present disclosure. In some examples, the process flow 900 may implement or be implemented by aspects of the wireless communications system 100, the wireless communications system 200, the timing diagram 300, the timing diagram 400, the timing diagram 500, the timing diagram 600, the timing diagram 700, and the timing diagram 800. For example, the process flow 900 may include one or more network entities 105 and one or more UEs 115 (e.g., a UE 115-b), which may be examples of the corresponding devices as described with reference to FIG. 1. In some examples, the UE 115-b may implement a rule associated with applying one or more reserved bits in a RAR message or absolute TA command received by the UE 115-b to determine a TAG associated with the network entity 105-c or the network entity 105-d.

At 910, the UE 115-b may receive, from a TRP 905-a (e.g., first TRP associated with a first CORESET pool index value), from a TRP 905-b (e.g., a second TRP associated with a second CORESET pool index value), or both, a control message indicating a set of TAGs, where a first TAG (e.g., TAG1) from the set of TAGs is associated with the first CORESET pool index (e.g., CORESET pool index=0) and a second TAG (e.g., TAG2) from the set of TAGs is associated with a second CORESET pool index (e.g., CORESET pool index=1). In some examples, the first CORESET pool index may be associated with a serving PCI.

In some examples, at 915, the UE 115-b may receive, from a TRP 905 such as the TRP 905-b in the context of the process flow 900, a first downlink message (e.g., PDCCH order) that triggers a random access procedure and associates the random access procedure with the serving PCI or an additional PCI that is different from the serving PCI.

In some cases, at 920, the UE 115-b may transmit, to the TRP 905-b, an initial uplink message (e.g., PRACH preamble) of a random access procedure.

At 925, the UE 115-b may receive, from the TRP 905-b in response to the initial uplink message (e.g., PRACH preamble) of the random access procedure, a second downlink message (e.g., RAR message or absolute TA command MAC-CE), the second downlink message including one or more reserved bits that indicate one of the first TAG or the second TAG.

At 930, the UE 115-b may select one of the first TAG or the second TAG based on a rule for application of the one or more reserved bits. In some examples, the rule for application of the one or more reserved bits may be based on the random access procedure being associated with the serving PCI or the additional PCI. For example, the random access procedure may be associated with the additional PCI and the rule for application of the one or more reserved bits is indicative that the UE 115-b is to ignore the one or more reserved bits based on the random access procedure being associated with the additional PCI. In such cases, the UE 115-b may select the selected TAG based on a configuration associated with the additional PCI.

In some examples, the rule for application of the one or more reserved bits may be based on a multi-TRP communication mode (e.g., an inter-cell mode or an intra-cell mode) of the UE 115-b at a time the second downlink message is received or is to be applied. For example, the multi-TRP communication mode of the UE 115-b may be an inter-cell mode and the rule for application of the one or more reserved bits may be indicative that the UE 115-b is to ignore the one or more reserved bits based on the UE 115-b being in the inter-cell mode, as indicated by at least one active TCI state of the UE 115-b being associated with an additional PCI that is different from a serving PCI. In another example, the multi-TRP communication mode of the UE 115-b may be an intra-cell mode and the rule for application of the one or more reserved bits may be indicative that the UE 115-b is to select the selected TAG using the one or more reserved bits based on the UE 115-b being in the intra-cell mode, as indicated by all active TCI states of the UE 115-b being associated with a serving PCI.

In some examples, the UE 115-b may select the selected TAG based on the indication of the one or more reserved bits.

In some examples, at 935, the UE 115-b may delay communicating in accordance with the selected TAG based on the UE 115-b operating in an inter-cell mode at a time the second downlink message is received or is to be applied. In such cases, the second CORESET pool index being associated with one or more TCI states that are associated with an additional PCI may be indicative that the UE 115-b is operating in the inter-cell mode

At 940, the UE 115-b may communicate (e.g., with the TRP 905-b) in accordance with the selected TAG (e.g., one of the first TAG or the second TAG) based on the selection. In some examples, the UE 115-b may communicate in accordance with the select TAG, after the delaying, based on the second CORESET pool index being associated with one or more TCI states that are associated with the serving PCI as a result of activation of the serving PCI for the second CORESET pool index. In some other examples, the UE 115-b may communicate in accordance with the select TAG based on the UE 115-b operating in an intra-cell mode at a time the second downlink message is received or is to be applied. In such cases, both the first CORESET pool index and the second CORESET pool index being associated with one or more TCI states that are associated with the serving PCI may be indicative that the UE 115-b is operating in the intra-cell mode.

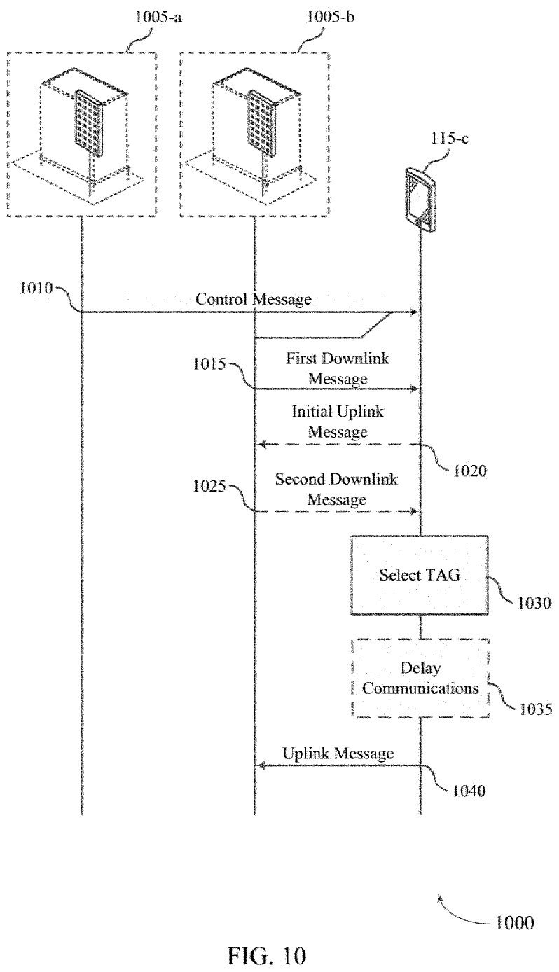

FIG. 10 illustrates an example of a process flow 1000 that supports PRACH enhancements for dynamic switching between inter-cell and intra-cell multi-TRPs in accordance with one or more aspects of the present disclosure. In some examples, the process flow 1000 may implement or be implemented by aspects of the wireless communications system 100, the wireless communications system 200, the timing diagram 300, the timing diagram 400, the timing diagram 500, the timing diagram 600, the timing diagram 700, the timing diagram 800, and the process flow 900. For example, the process flow 1000 may include one or more network entities 105 and one or more UEs 115 (e.g., a UE 115-c), which may be examples of the corresponding devices as described with reference to FIG. 1. In some examples, the UE 115-c may apply a state indicated via an order included in a control message based on an operational mode of the UE 115-c.

At 1010, the UE 115-c may receive, from a TRP 1005-a (e.g., first TRP associated with a first CORESET pool index value), from a TRP 1005-b (e.g., a second TRP associated with a second CORESET pool index value), or both, a control message indicating a set of TAGs, where a first TAG (e.g., TAG1) from the set of TAGs is associated with the first CORESET pool index (e.g., CORESET pool index=0) and a second TAG (e.g., TAG2) from the set of TAGs is associated with a second CORESET pool index (e.g., CORESET pool index=1). In some examples, the first CORESET pool index may be associated with a serving PCI.

At 1015, the UE 115-c may receive, from a TRP 1005, such as the TRP 1005-b in the context of the process flow 1000, a first downlink message (e.g., PDCCH order) that triggers a random access procedure. The first downlink message may indicate a state from a set of states, where each state from the set of states is associated with a PCI from a set of PCIs and is indicative of a TAG that is to be used by the UE 115-c.

In some examples, the set of states may include a first state indicating the first TAG associated with a serving PCI from the set of PCIs, a second state indicating the second TAG associated with the serving PCI, and one or more third states each indicating for the UE 115-c to transmit the uplink message in accordance with a random access procedure configuration associated with respective additional PCIs from the set of PCIs.

Additionally, or alternatively, a quantity of the set of states may be based on the multi-TRP communication mode of the UE 115-c at a time the first downlink message is received or an initial uplink message of the random access procedure is transmitted. For example, the UE 115-c may operate in an intra-cell multi-TRP mode at the time the first downlink message is received or the initial uplink message of the random access procedure is transmitted. In such cases, the set of states may include a first state indicating the first TAG associated with a serving PCI from the set of PCIs and a second state indicating the second TAG associated with the serving PCI. In some cases, operation of the UE 115-c in the intra-cell multi-TRP mode may be indicated by the first CORESET pool index and the second CORESET pool index being associated with the serving PCI.

In another example, the UE 115-c may operate in an inter-cell multi-TRP mode at the time the downlink message is received or the initial uplink message of the random access procedure is transmitted. In such cases, the set of states includes a first state indicating for the UE 115-c to transmit the uplink message in accordance with a first random access procedure configuration associated with a serving PCI from the set of PCIs and one or more second states indicating for the UE 115-c to transmit the uplink message in accordance with a respective random access configuration procedure configuration associated with each additional PCI from the set of PCIs. In some cases, operation of the UE 115-c in the inter-cell multi-TRP mode may be indicated by the first CORESET pool index being associated with the serving PCI and the second CORESET pool index being associated with the additional PCI.

In some examples, the set of states may include a first state indicating whether the random access procedure is associated with an inter-cell multi-TRP communication mode or an intra-cell multi-TRP communication mode, a second state indicating for the UE 115-c to transmit the uplink message in accordance with a first random access procedure configuration associated with a serving PCI from the set of PCIs, and one or more third states each indicating for the UE 115-c to transmit the uplink message in accordance with a random access procedure configuration associated with respective additional PCIs from the set of PCIs.

In some examples, the set of states may include a first state indicating for the UE 115-c to transmit the uplink message in accordance with a first random access procedure configuration associated with a serving PCI from the set of PCIs and one or more second states indicating for the UE 115-c to transmit the uplink message in accordance with an respective random access configuration procedure configuration associated with respective additional PCIs from the set of PCIs.

In some examples, at 1020, the UE 115-c may transmit (e.g., to the TRP 1005-b) the initial uplink message (e.g., PRACH preamble) of the random access procedure.

At 1025, the UE 115-b may receive, from the TRP 1005-b in response to the initial uplink message of a random access procedure, a second downlink message (e.g., RAR or absolute TA command). The second downlink message may include a TA command associated with the indicated state.

At 1030, the UE 115-c may select a selected TAG from the first TAG or the second TAG based on the indicated state and on a multi-TRP communication mode of the UE 115-c. In some examples, the UE 115-c may determine the selected TAG based on a CORESET pool index associated with the first downlink message triggering the random access procedure. Additionally, or alternatively, the UE 115-c may determine the selected TAG based on the indicated state in the first downlink message triggering the random access procedure.

In some examples, the UE 115-c may select the selected TAG based on a CORESET pool index associated with the first downlink message triggering the random access procedure and based on the UE 115-c operating in an inter-cell multi-TRP communication mode at a time the first downlink message is received or the initial uplink message of the random access procedure is transmitted. In such cases, the downlink message triggering the random access procedure may indicate a state that further indicates the random access procedure is associated with a PCI for the inter-cell mode.

In some examples, the UE 115-c may select the selected TAG based on the indicated state and based on the UE 115-c operating in an intra-cell multi-TRP communication mode at the time the first downlink message is received or the initial uplink message of the random access procedure is transmitted

In some cases, at 1035, the selected TAG may be the second TAG and the UE 115-c may delay transmission of an uplink message of the random access procedure based on the UE 115-c operating in an inter-cell multi-TRP communication mode at a time the second downlink message is received or is to be applied. In such cases, the selected CORESET pool index being associated with one or more TCI states that are associated with an additional PCI may be indicative that the UE 115-c is operating in the inter-cell multi-TRP communication mode.

At 1040, the UE 115-c may transmit (e.g., to the TRP 1005-b) an uplink message (e.g., after the random access procedure) using the selected TAG (e.g., using a TA associated with the selected TAG. In some examples, the UE 115-c may transmit the uplink message in accordance with the selected TAG (e.g., second TAG), after the delaying, based on the second CORESET pool index being associated with the one or more TCI states that are associated with the serving PCI as a result of activation of the serving PCI for the second CORESET pool index.

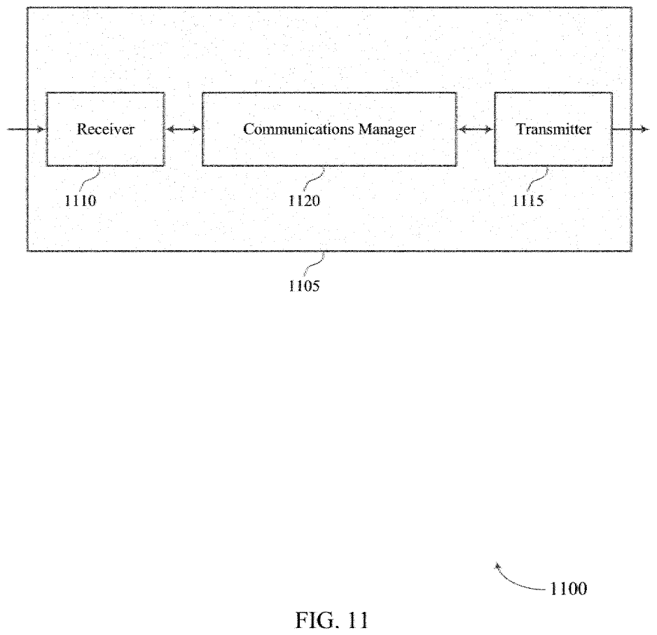

FIG. 11 illustrates a block diagram 1100 of a device 1105 that supports PRACH enhancements for dynamic switching between inter-cell and intra-cell multi-TRPs in accordance with one or more aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to PRACH enhancements for dynamic switching between inter-cell and intra-cell multi-TRPs). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to PRACH enhancements for dynamic switching between inter-cell and intra-cell multi-TRPs). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of PRACH enhancements for dynamic switching between inter-cell and intra-cell multi-TRPs as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a UE in accordance with examples as disclosed herein. For example, the communications manager 1120 may be configured as or otherwise support a means for receiving a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI. The communications manager 1120 may be configured as or otherwise support a means for receiving, in response to an initial uplink message of a random access procedure, a first downlink message of the random access procedure, the first downlink message including one or more reserved bits that indicate one of the first TAG or the second TAG. The communications manager 1120 may be configured as or otherwise support a means for selecting one of the first TAG or the second TAG based on a rule for application of the one or more reserved bits. The communications manager 1120 may be configured as or otherwise support a means for communicating in accordance with a selecting TAG, which is one of the first TAG or the second TAG, based on the selection.

Additionally, or alternatively, the communications manager 1120 may support wireless communications at a UE in accordance with examples as disclosed herein. For example, the communications manager 1120 may be configured as or otherwise support a means for receiving a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI. The communications manager 1120 may be configured as or otherwise support a means for receiving a downlink message that triggers a random access procedure, the downlink message indicating a state from a set of states, where each state from the set of states is associated with a PCI from a set of PCIs and is indicative of a TAG that is to be used by the UE. The communications manager 1120 may be configured as or otherwise support a means for selecting a selected TAG from the first TAG, or the second TAG based on the indicated state and on a multi TRP communication mode of the UE. The communications manager 1120 may be configured as or otherwise support a means for transmitting an uplink message using the selected TAG.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for TAG indication associated with dynamic switching between inter-cell and intra-cell multi-TRPs which may result in reduced processing, reduced power consumption, more efficient utilization of communication resources, among other advantages.

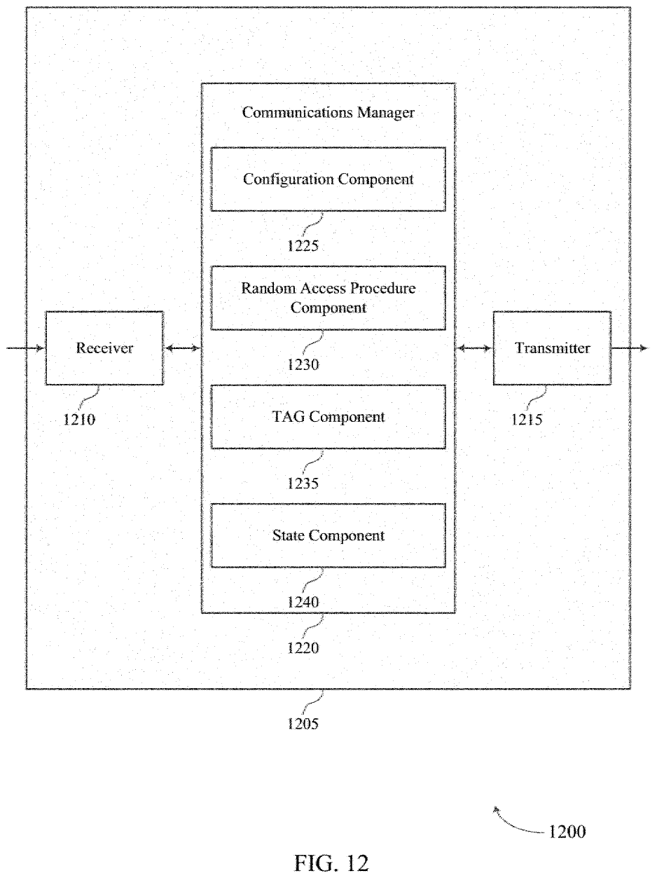

FIG. 12 illustrates a block diagram 1200 of a device 1205 that supports PRACH enhancements for dynamic switching between inter-cell and intra-cell multi-TRPs in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to PRACH enhancements for dynamic switching between inter-cell and intra-cell multi-TRPs). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to PRACH enhancements for dynamic switching between inter-cell and intra-cell multi-TRPs). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of PRACH enhancements for dynamic switching between inter-cell and intra-cell multi-TRPs as described herein. For example, the communications manager 1220 may include a configuration component 1225, a random access procedure component 1230, a TAG component 1235, a state component 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a UE in accordance with examples as disclosed herein. The configuration component 1225 may be configured as or otherwise support a means for receiving a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI. The random access procedure component 1230 may be configured as or otherwise support a means for receiving, in response to an initial uplink message of a random access procedure, a first downlink message of the random access procedure, the first downlink message including one or more reserved bits that indicate one of the first TAG or the second TAG. The TAG component 1235 may be configured as or otherwise support a means for selecting one of the first TAG or the second TAG based on a rule for application of the one or more reserved bits. The TAG component 1235 may be configured as or otherwise support a means for communicating in accordance with a selected TAG, which is one of the first TAG or the second TAG, based on the selection.

Additionally, or alternatively, the communications manager 1220 may support wireless communications at a UE in accordance with examples as disclosed herein. The configuration component 1225 may be configured as or otherwise support a means for receiving a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI. The state component 1240 may be configured as or otherwise support a means for receiving a downlink message that triggers a random access procedure, the downlink message indicating a state from a set of states, where each state from the set of states is associated with a PCI from a set of PCIs and is indicative of a TAG that is to be used by the UE. The TAG component 1235 may be configured as or otherwise support a means for selecting a selected TAG from the first TAG, or the second TAG based on the indicated state and on a multi TRP communication mode of the UE. The random access procedure component 1230 may be configured as or otherwise support a means for transmitting an uplink message using the selected TAG.

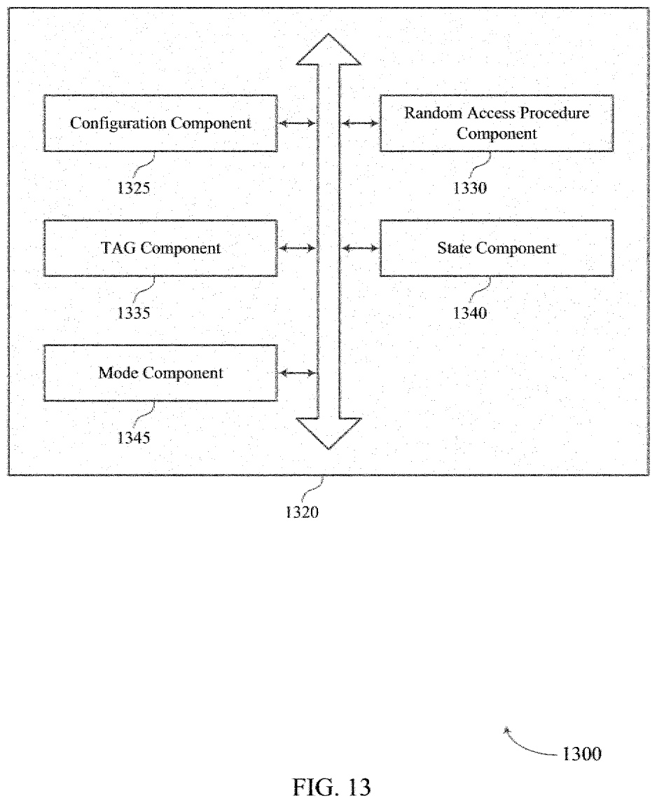

FIG. 13 illustrates a block diagram 1300 of a communications manager 1320 that supports PRACH enhancements for dynamic switching between inter-cell and intra-cell multi-TRPs in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of PRACH enhancements for dynamic switching between inter-cell and intra-cell multi-TRPs as described herein. For example, the communications manager 1320 may include a configuration component 1325, a random access procedure component 1330, a TAG component 1335, a state component 1340, a mode component 1345, or any combination thereof. Each of these components may communicate, directly or indirectly, with one another (e.g., via one or more buses).

The communications manager 1320 may support wireless communications at a UE in accordance with examples as disclosed herein. The configuration component 1325 may be configured as or otherwise support a means for receiving a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI. The random access procedure component 1330 may be configured as or otherwise support a means for receiving, in response to an initial uplink message of a random access procedure, a first downlink message of the random access procedure, the first downlink message including one or more reserved bits that indicate one of the first TAG or the second TAG. The TAG component 1335 may be configured as or otherwise support a means for selecting one of the first TAG or the second TAG based on a rule for application of the one or more reserved bits. In some examples, the TAG component 1335 may be configured as or otherwise support a means for communicating in accordance with a selected TAG, which is one of the first TAG or the second TAG, based on the selection.

In some examples, the random access procedure component 1330 may be configured as or otherwise support a means for receiving a second downlink message that triggers the random access procedure and associates the random access procedure with the serving PCI or an additional PCI that is different from the serving PCI, where the rule for application of the one or more reserved bits is based on the random access procedure being associated with the serving PCI or the additional PCI.

In some examples, the random access procedure is associated with the additional PCI. In some examples, the rule for application of the one or more reserved bits is indicative that the UE is to ignore the one or more reserved bits based on the random access procedure being associated with the additional PCI.

In some examples, to support selecting one of the first TAG or the second TAG, the TAG component 1335 may be configured as or otherwise support a means for selecting the selected TAG based on a configuration associated with the additional PCI.

In some examples, to support selecting one of the first TAG or the second TAG, the TAG component 1335 may be configured as or otherwise support a means for selecting the selected TAG based on the indication of the one or more reserved bits.

In some examples, the selected TAG is the second TAG, and the mode component 1345 may be configured as or otherwise support a means for delaying the communicating in accordance with the second TAG based on the UE operating in an inter-cell mode at a time the first downlink message is received or is to be applied, where the second CORESET pool index being associated with one or more TCI states that are associated with an additional PCI is indicative that the UE is operating in the inter-cell mode.

In some examples, to support communicating in accordance with the selected TAG, the TAG component 1335 may be configured as or otherwise support a means for communicating in accordance with the second TAG, after the delaying, based on the second CORESET pool index being associated with one or more TCI states that are associated with the serving PCI as a result of activation of the serving PCI for the second CORESET pool index.

In some examples, to support communicating in accordance with the selected TAG, the mode component 1345 may be configured as or otherwise support a means for communicating in accordance with the selected TAG based on the UE operating in an intra-cell mode at a time the first downlink message is received or is to be applied, where both the first CORESET pool index and the second CORESET pool index being associated with one or more TCI states that are associated with the serving PCI is indicative that the UE is operating in the intra-cell mode.

In some examples, the rule for application of the one or more reserved bits is based on a multi TRP communication mode of the UE at a time the first downlink message is received or is to be applied.

In some examples, the multi TRP communication mode of the UE is an inter-cell mode. In some examples, the rule for application of the one or more reserved bits is indicative that the UE is to ignore the one or more reserved bits based on the UE being in the inter-cell mode, as indicated by at least one active TCI state of the UE being associated with an additional PCI that is different from the serving PCI.

In some examples, the multi TRP communication mode of the UE is an intra-cell mode. In some examples, the rule for application of the one or more reserved bits is indicative that the UE is to select the selected TAG using the one or more reserved bits based on the UE being in the intra-cell mode, as indicated by all active TCI states of the UE being associated with the serving PCI.

In some examples, the first downlink message of the random access procedure is a RAR message or an absolute TA command MACE-CE.

Additionally, or alternatively, the communications manager 1320 may support wireless communications at a UE in accordance with examples as disclosed herein. In some examples, the configuration component 1325 may be configured as or otherwise support a means for receiving a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI. The state component 1340 may be configured as or otherwise support a means for receiving a downlink message that triggers a random access procedure, the downlink message indicating a state from a set of states, where each state from the set of states is associated with a PCI from a set of PCIs and is indicative of a TAG that is to be used by the UE. In some examples, the TAG component 1335 may be configured as or otherwise support a means for selecting a selected TAG from the first TAG, or the second TAG based on the indicated state and on a multi TRP communication mode of the UE. In some examples, the random access procedure component 1330 may be configured as or otherwise support a means for transmitting an uplink message using the selected TAG.

In some examples, the set of states includes a first state indicating the first TAG associated with the serving PCI from the set of PCIs, a second state indicating the second TAG associated with the serving PCI, and one or more third states each indicating for the UE to transmit the uplink message in accordance with a random access procedure configuration associated with respective additional PCIs from the set of PCIs.

In some examples, the selected TAG is the second TAG, and the random access procedure component 1330 may be configured as or otherwise support a means for transmitting an initial uplink message of the random access procedure. In some examples, the selected TAG is the second TAG, and the random access procedure component 1330 may be configured as or otherwise support a means for receiving a second downlink message in response to the initial uplink message, where the second downlink message includes a TA command associated with the indicated state. In some examples, the selected TAG is the second TAG, and the mode component 1345 may be configured as or otherwise support a means for delaying the transmission of the uplink message using the second TAG based on the UE operating in an inter-cell multi TRP communication mode at a time the second downlink message is received or is to be applied, where the second CORESET pool index being associated with one or more TCI states that are associated with an additional PCI is indicative that the UE is operating in the inter-cell multi TRP communication mode.

In some examples, to support transmitting the uplink message, the TAG component 1335 may be configured as or otherwise support a means for transmitting the uplink message in accordance with the second TAG, after the delaying, based on the second CORESET pool index being associated with the one or more TCI states that are associated with the serving PCI as a result of activation of the serving PCI for the second CORESET pool index.

In some examples, a quantity of the set of states is based on the multi TRP communication mode of the UE at a time the downlink message is received or an initial uplink message of the random access procedure is transmitted.

In some examples, the mode component 1345 may be configured as or otherwise support a means for operating the UE in an intra-cell multi TRP mode at the time the downlink message is received or the initial uplink message of the random access procedure is transmitted, where the set of states includes a first state indicating the first TAG associated with the serving PCI from the set of PCIs and a second state indicating the second TAG associated with the serving PCI.

In some examples, operation of the UE in the intra-cell multi TRP mode is indicated by the first CORESET pool index and the second CORESET pool index being associated with the serving PCI.

In some examples, the mode component 1345 may be configured as or otherwise support a means for operating the UE in an inter-cell multi TRP mode at the time the downlink message is received or the initial uplink message of the random access procedure is transmitted, where the set of states includes a first state indicating for the UE to transmit the uplink message in accordance with a first random access procedure configuration associated with the serving PCI from the set of PCIs and one or more second states indicating for the UE to transmit the uplink message in accordance with a respective random access configuration procedure configuration associated with each additional PCI from the set of PCIs.

In some examples, operation of the UE in the inter-cell multi TRP mode is indicated by the first CORESET pool index being associated with the serving PCI and the second CORESET pool index being associated with an additional PCI.

In some examples, the set of states includes a first state indicating whether the random access procedure is associated with an inter-cell multi TRP communication mode or an intra-cell multi TRP communication mode, a second state indicating for the UE to transmit the uplink message in accordance with a first random access procedure configuration associated with the serving PCI from the set of PCIs, and one or more third states each indicating for the UE to transmit the uplink message in accordance with a random access procedure configuration associated with respective additional PCIs from the set of PCIs.

In some examples, to support selecting the selected TAG, the TAG component 1335 may be configured as or otherwise support a means for determining the selected TAG based on a CORESET pool index associated with the downlink message triggering the random access procedure.

In some examples, the random access procedure component 1330 may be configured as or otherwise support a means for transmitting an initial uplink message of the random access procedure. In some examples, the random access procedure component 1330 may be configured as or otherwise support a means for receiving a second downlink message in response to the initial uplink message, where the second downlink message includes a TA command associated with the second CORESET pool index. In some examples, the mode component 1345 may be configured as or otherwise support a means for delaying the transmission of the uplink message in accordance with the selected TAG based on the UE operating in the inter-cell multi TRP communication mode at a time the second downlink message is received or is to be applied, where the second CORESET pool index being associated with one or more TCI states that are associated with an additional PCI is indicative that the UE is operating in the inter-cell multi TRP communication mode.

In some examples, to support transmitting the uplink message, the TAG component 1335 may be configured as or otherwise support a means for transmitting the uplink message in accordance with the second TAG, after the delaying, based on the second CORESET pool index being associated with one or more TCI states that are associated with the serving PCI as a result of activation of the serving PCI for the second CORESET pool index.

In some examples, to support selecting the selected TAG, the TAG component 1335 may be configured as or otherwise support a means for determining the selected TAG based on the indicated state in the downlink message triggering the random access procedure.

In some examples, the set of states includes a first state indicating for the UE to transmit the uplink message in accordance with a first random access procedure configuration associated with the serving PCI from the set of PCIs and one or more second states indicating for the UE to transmit the uplink message in accordance with an respective random access configuration procedure configuration associated with respective additional PCIs from the set of PCIs.

In some examples, to support selecting the selected TAG, the TAG component 1335 may be configured as or otherwise support a means for selecting the selected TAG based on a CORESET pool index associated with the downlink message triggering the random access procedure and based on the UE operating in an intra-cell multi TRP communication mode at a time the downlink message is received or an initial uplink message of the random access procedure is transmitted.

In some examples, to support selecting the selected TAG, the TAG component 1335 may be configured as or otherwise support a means for selecting the selected TAG based on the indicated state and based on the UE operating in an inter-cell multi TRP communication mode at a time downlink message is received or an initial uplink message of the random access procedure is transmitted.

In some examples, the downlink message that triggers the random access procedure is a PDCCH order DCI.

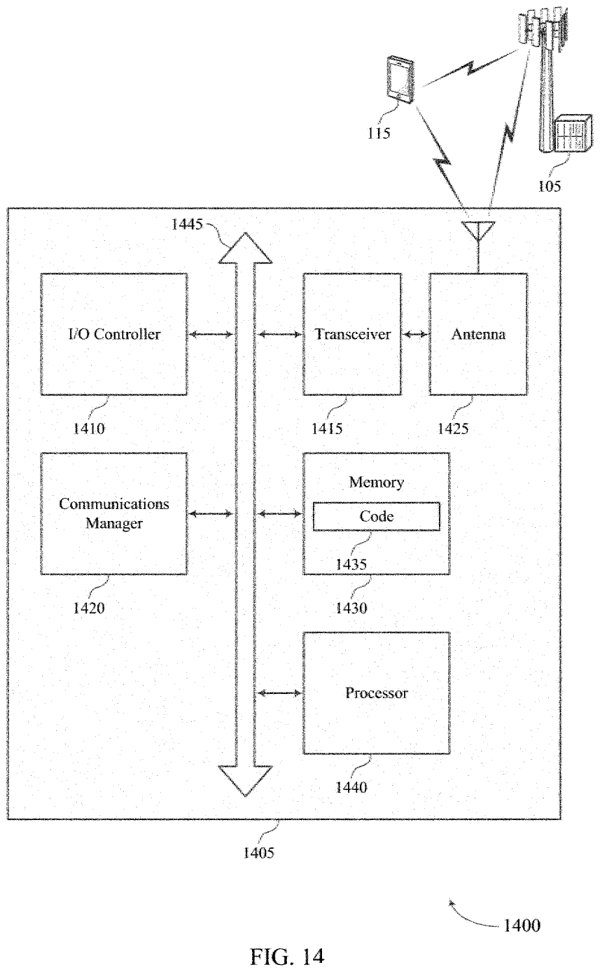

FIG. 14 illustrates a diagram of a system 1400 including a device 1405 that supports PRACH enhancements for dynamic switching between inter-cell and intra-cell multi-TRPs in accordance with one or more aspects of the present disclosure. The device 1405 may be an example of or include the components of a device 1105, a device 1205, or a UE 115 as described herein. The device 1405 may communicate (e.g., wirelessly) with one or more network entities 105, one or more UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting PRACH enhancements for dynamic switching between inter-cell and intra-cell multi-TRPs). For example, the device 1405 or a component of the device 1405 may include a processor 1440 and memory 1430 coupled with or to the processor 1440, the processor 1440 and memory 1430 configured to perform various functions described herein.

The communications manager 1420 may support wireless communications at a UE in accordance with examples as disclosed herein. For example, the communications manager 1420 may be configured as or otherwise support a means for receiving a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI. The communications manager 1420 may be configured as or otherwise support a means for receiving, in response to an initial uplink message of a random access procedure, a first downlink message of the random access procedure, the first downlink message including one or more reserved bits that indicate one of the first TAG or the second TAG. The communications manager 1420 may be configured as or otherwise support a means for selecting one of the first TAG or the second TAG based on a rule for application of the one or more reserved bits. The communications manager 1420 may be configured as or otherwise support a means for communicating in accordance with a selecting TAG, which is one of the first TAG or the second TAG, based on the selection.

Additionally, or alternatively, the communications manager 1420 may support wireless communications at a UE in accordance with examples as disclosed herein. For example, the communications manager 1420 may be configured as or otherwise support a means for receiving a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI. The communications manager 1420 may be configured as or otherwise support a means for receiving a downlink message that triggers a random access procedure, the downlink message indicating a state from a set of states, where each state from the set of states is associated with a PCI from a set of PCIs and is indicative of a TAG that is to be used by the UE. The communications manager 1420 may be configured as or otherwise support a means for selecting a selected TAG from the first TAG, or the second TAG based on the indicated state and on a multi TRP communication mode of the UE. The communications manager 1420 may be configured as or otherwise support a means for transmitting an uplink message using the selected TAG.

By including or configuring the communications manager 1420 in accordance with examples as described herein, the device 1405 may support techniques for TAG indication associated with dynamic switching between inter-cell and intra-cell multi-TRPs which may result in improved communication reliability, reduced latency, improved user experience related to reduced processing, reduced power consumption, more efficient utilization of communication resources, improved coordination between devices, longer battery life, improved utilization of processing capability, among other advantages.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of PRACH enhancements for dynamic switching between inter-cell and intra-cell multi-TRPs as described herein, or the processor 1440 and the memory 1430 may be otherwise configured to perform or support such operations.

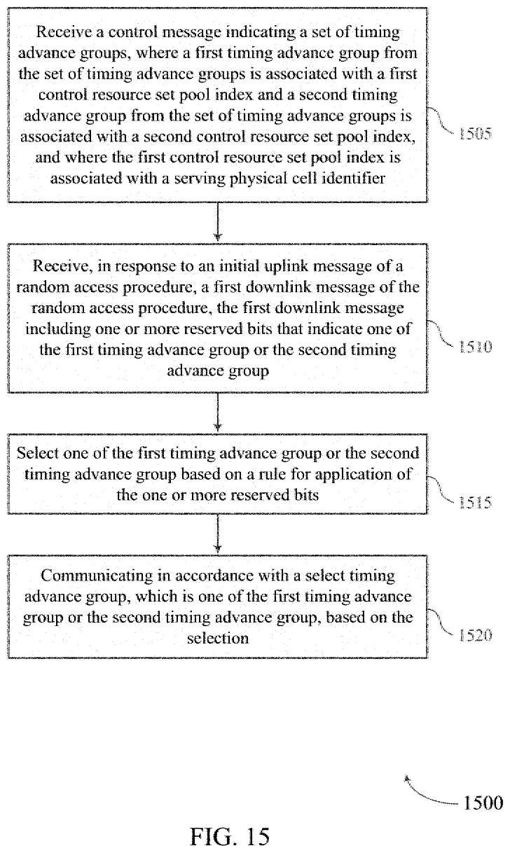

FIG. 15 illustrates a flowchart showing a method 1500 that supports PRACH enhancements for dynamic switching between inter-cell and intra-cell multi-TRPs in accordance with one or more aspects of the present disclosure. The operations of the method 1500 may be implemented by a UE or its components as described herein. For example, the operations of the method 1500 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1505, the method may include receiving a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI. The operations of 1505 may be performed in accordance with examples as disclosed herein. In some examples, aspects of the operations of 1505 may be performed by a configuration component 1325 as described with reference to FIG. 13.

At 1510, the method may include receiving, in response to an initial uplink message of a random access procedure, a first downlink message of the random access procedure, the first downlink message including one or more reserved bits that indicate one of the first TAG or the second TAG. The operations of 1510 may be performed in accordance with examples as disclosed herein. In some examples, aspects of the operations of 1510 may be performed by a random access procedure component 1330 as described with reference to FIG. 13.

At 1515, the method may include selecting one of the first TAG or the second TAG based on a rule for application of the one or more reserved bits. The operations of 1515 may be performed in accordance with examples as disclosed herein. In some examples, aspects of the operations of 1515 may be performed by a TAG component 1335 as described with reference to FIG. 13.

At 1520, the method may include communicating in accordance with a selected TAG, which is one of the first TAG or the second TAG, based on the selection. The operations of 1520 may be performed in accordance with examples as disclosed herein. In some examples, aspects of the operations of 1520 may be performed by a TAG component 1335 as described with reference to FIG. 13.

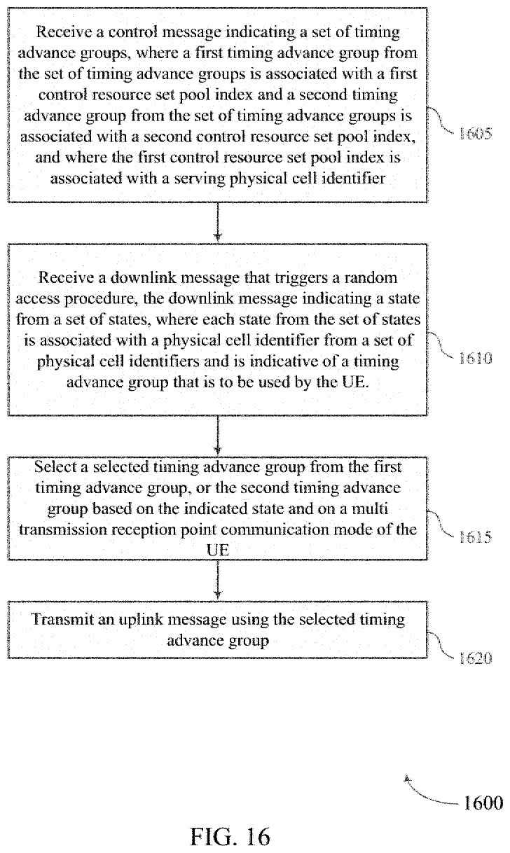

FIG. 16 illustrates a flowchart showing a method 1600 that supports PRACH enhancements for dynamic switching between inter-cell and intra-cell multi-TRPs in accordance with one or more aspects of the present disclosure. The operations of the method 1600 may be implemented by a UE or its components as described herein. For example, the operations of the method 1600 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1605, the method may include receiving a control message indicating a set of TAGs, where a first TAG from the set of TAGs is associated with a first CORESET pool index and a second TAG from the set of TAGs is associated with a second CORESET pool index, and where the first CORESET pool index is associated with a serving PCI. The operations of 1605 may be performed in accordance with examples as disclosed herein. In some examples, aspects of the operations of 1605 may be performed by a configuration component 1325 as described with reference to FIG. 13.

At 1610, the method may include receiving a downlink message that triggers a random access procedure, the downlink message indicating a state from a set of states, where each state from the set of states is associated with a PCI from a set of PCIs and is indicative of a TAG that is to be used by the UE. The operations of 1610 may be performed in accordance with examples as disclosed herein. In some examples, aspects of the operations of 1610 may be performed by a state component 1340 as described with reference to FIG. 13.

At 1615, the method may include selecting a selected TAG from the first TAG, or the second TAG based on the indicated state and on a multi TRP communication mode of the UE. The operations of 1615 may be performed in accordance with examples as disclosed herein. In some examples, aspects of the operations of 1615 may be performed by a TAG component 1335 as described with reference to FIG. 13.

At 1620, the method may include transmitting an uplink message using the selected TAG. The operations of 1620 may be performed in accordance with examples as disclosed herein. In some examples, aspects of the operations of 1620 may be performed by a random access procedure component 1330 as described with reference to FIG. 13.

The following provides an overview of aspects of the present disclosure:

Aspect 1: A method for wireless communications at a UE, comprising: receiving a control message indicating a set of TAGs, wherein a first TAG from the set of TAGs is associated with a first CORESET pool index and a second TAG from the set of TAGs is associated with a second CORESET pool index, and wherein the first CORESET pool index is associated with a serving PCI; receiving, in response to an initial uplink message of a random access procedure, a first downlink message of the random access procedure, the first downlink message including one or more reserved bits that indicate one of the first TAG or the second TAG; selecting one of the first TAG or the second TAG based at least in part on a rule for application of the one or more reserved bits; and communicating in accordance with a selected TAG, which is one of the first TAG or the second TAG, based at least in part on the selection.

Aspect 2: The method of aspect 1, further comprising: receiving a second downlink message that triggers the random access procedure and associates the random access procedure with the serving PCI or an additional PCI that is different from the serving PCI, wherein the rule for application of the one or more reserved bits is based at least in part on the random access procedure being associated with the serving PCI or the additional PCI.

Aspect 3: The method of aspect 2, wherein the random access procedure is associated with the additional PCI, and the rule for application of the one or more reserved bits is indicative that the UE is to ignore the one or more reserved bits based at least in part on the random access procedure being associated with the additional PCI.

Aspect 4: The method of aspect 3, wherein selecting one of the first TAG or the second TAG comprises: selecting the selected TAG based on a configuration associated with the additional PCI.

Aspect 5: The method of aspect 2, wherein the random access procedure is associated with the serving PCI, and wherein selecting one of the first TAG or the second TAG comprises: selecting the selected TAG based at least in part on the indication of the one or more reserved bits.

Aspect 6: The method of aspect 5, wherein the selected TAG is the second TAG, the method further comprising: delaying the communicating in accordance with the second TAG based at least in part on the UE operating in an inter-cell mode at a time the first downlink message is received or is to be applied, wherein the second CORESET pool index being associated with one or more TCI states that are associated with an additional PCI is indicative that the UE is operating in the inter-cell mode.

Aspect 7: The method of aspect 6, wherein communicating in accordance with the selected TAG comprises: communicating in accordance with the second TAG, after the delaying, based at least in part on the second CORESET pool index being associated with one or more TCI states that are associated with the serving PCI as a result of activation of the serving PCI for the second CORESET pool index.

Aspect 8: The method of any of aspects 5 through 7, wherein communicating in accordance with the selected TAG comprises: communicating in accordance with the selected TAG based at least in part on the UE operating in an intra-cell mode at a time the first downlink message is received or is to be applied, wherein both the first CORESET pool index and the second CORESET pool index being associated with one or more TCI states that are associated with the serving PCI is indicative that the UE is operating in the intra-cell mode.

Aspect 9: The method of aspect 1, wherein the rule for application of the one or more reserved bits is based at least in part on a multi TRP communication mode of the UE at a time the first downlink message is received or is to be applied.

Aspect 10: The method of aspect 9, wherein the multi TRP communication mode of the UE is an inter-cell mode, and the rule for application of the one or more reserved bits is indicative that the UE is to ignore the one or more reserved bits based at least in part on the UE being in the inter-cell mode, as indicated by at least one active TCI state of the UE being associated with an additional PCI that is different from the serving PCI.

Aspect 11: The method of aspects 9, wherein the multi TRP communication mode of the UE is an intra-cell mode, and the rule for application of the one or more reserved bits is indicative that the UE is to select the selected TAG using the one or more reserved bits based at least in part on the UE being in the intra-cell mode, as indicated by all active TCI states of the UE being associated with the serving PCI.

Aspect 12: The method of any of aspects 1 through 11, wherein the first downlink message of the random access procedure is a RAR message or an absolute TA command MAC-CE.

Aspect 13: A method for wireless communications at a UE, comprising: receiving a control message indicating a set of TAGs, wherein a first TAG from the set of TAGs is associated with a first CORESET pool index and a second TAG from the set of TAGs is associated with a second CORESET pool index, and wherein the first CORESET pool index is associated with a serving PCI; receiving a downlink message that triggers a random access procedure, the downlink message indicating a state from a set of states, wherein each state from the set of states is associated with a PCI from a set of PCIs and is indicative of a TAG that is to be used by the UE; selecting a selected TAG from the first TAG, or the second TAG based at least in part on the indicated state and on a multi TRP communication mode of the UE; and transmitting an uplink message using the selected TAG.

Aspect 14: The method of aspect 13, wherein the set of states comprises a first state indicating the first TAG associated with the serving PCI from the set of PCIs, a second state indicating the second TAG associated with the serving PCI, and one or more third states each indicating for the UE to transmit the uplink message in accordance with a random access procedure configuration associated with respective additional PCIs from the set of PCIs.

Aspect 15: The method of aspect 14, wherein the selected TAG is the second TAG, the method further comprising: transmitting an initial uplink message of the random access procedure; receiving a second downlink message in response to the initial uplink message, wherein the second downlink message includes a timing advance command associated with the indicated state; and delaying the transmission of the uplink message using the second TAG based at least in part on the UE operating in an inter-cell multi TRP communication mode at a time the second downlink message is received or is to be applied, wherein the second CORESET pool index being associated with one or more TCI states that are associated with an additional PCI is indicative that the UE is operating in the inter-cell multi TRP communication mode.

Aspect 16: The method of aspect 15, wherein transmitting the uplink message comprises: transmitting the uplink message in accordance with the second TAG, after the delaying, based at least in part on the second CORESET pool index being associated with the one or more TCI states that are associated with the serving PCI as a result of activation of the serving PCI for the second CORESET pool index.

Aspect 17: The method of any of aspects 13 through 16, wherein a quantity of the set of states is based at least in part on the multi TRP communication mode of the UE at a time the downlink message is received or an initial uplink message of the random access procedure is transmitted.

Aspect 18: The method of aspect 17, further comprising: operating the UE in an intra-cell multi TRP mode at the time the downlink message is received or the initial uplink message of the random access procedure is transmitted, wherein the set of states comprises a first state indicating the first TAG associated with the serving PCI from the set of PCIs and a second state indicating the second TAG associated with the serving PCI.

Aspect 19: The method of aspect 18, wherein operation of the UE in the intra-cell multi TRP mode is indicated by the first CORESET pool index and the second CORESET pool index being associated with the serving PCI.

Aspect 20: The method of aspect 17, further comprising: operating the UE in an inter-cell multi TRP mode at the time the downlink message is received or the initial uplink message of the random access procedure is transmitted, wherein the set of states comprises a first state indicating for the UE to transmit the uplink message in accordance with a first random access procedure configuration associated with the serving PCI from the set of PCIs and one or more second states indicating for the UE to transmit the uplink message in accordance with a respective random access configuration procedure configuration associated with each additional PCI from the set of PCIs.

Aspect 21: The method of aspect 20, wherein operation of the UE in the inter-cell multi TRP mode is indicated by the first CORESET pool index being associated with the serving PCI and the second CORESET pool index being associated with an additional PCI.

Aspect 22: The method of aspect 13, wherein the set of states comprises a first state indicating whether the random access procedure is associated with an inter-cell multi TRP communication mode or an intra-cell multi TRP communication mode, a second state indicating for the UE to transmit the uplink message in accordance with a first random access procedure configuration associated with the serving PCI from the set of PCIs, and one or more third states each indicating for the UE to transmit the uplink message in accordance with a random access procedure configuration associated with respective additional PCIs from the set of PCIs.

Aspect 23: The method of aspect 22, wherein the downlink message triggering the random access procedure indicates the first state, and wherein the first state indicates that the random access procedure is associated with the intra-cell multi TRP communication mode, wherein selecting the selected TAG comprises: determining the selected TAG based at least in part on a CORESET pool index associated with the downlink message triggering the random access procedure.

Aspect 24: The method of aspect 23, further comprising: transmitting an initial uplink message of the random access procedure; receiving a second downlink message in response to the initial uplink message, wherein the second downlink message includes a timing advance command associated with the second CORESET pool index; and delaying the transmission of the uplink message in accordance with the selected TAG based at least in part on the UE operating in the inter-cell multi TRP communication mode at a time the second downlink message is received or is to be applied, wherein the second CORESET pool index being associated with one or more TCI states that are associated with an additional PCI is indicative that the UE is operating in the inter-cell multi TRP communication mode.

Aspect 25: The method of aspect 24, wherein transmitting the uplink message comprises: transmitting the uplink message in accordance with the second TAG, after the delaying, based at least in part on the second CORESET pool index being associated with one or more TCI states that are associated with the serving PCI as a result of activation of the serving PCI for the second CORESET pool index.

Aspect 26: The method of any of aspects 22 through 25, wherein the downlink message triggering the random access procedure indicates a state that further indicates that the random access procedure is associated with a PCI for the inter-cell multi TRP communication mode, wherein selecting the selected TAG comprises: determining the selected TAG based at least in part on the indicated state in the downlink message triggering the random access procedure.

Aspect 27: The method of aspect 13, wherein the set of states comprises a first state indicating for the UE to transmit the uplink message in accordance with a first random access procedure configuration associated with the serving PCI from the set of PCIs and one or more second states indicating for the UE to transmit the uplink message in accordance with an respective random access configuration procedure configuration associated with respective additional PCIs from the set of PCIs.

Aspect 28: The method of aspect 27, wherein selecting the selected TAG comprises: selecting the selected TAG based at least in part on a CORESET pool index associated with the downlink message triggering the random access procedure and based at least in part on the UE operating in an intra-cell multi TRP communication mode at a time the downlink message is received or an initial uplink message of the random access procedure is transmitted.

Aspect 29: The method of aspect 27, wherein selecting the selected TAG comprises: selecting the selected TAG based at least in part on the indicated state and based at least in part on the UE operating in an inter-cell multi TRP communication mode at a time downlink message is received or an initial uplink message of the random access procedure is transmitted.

Aspect 30: The method of any of aspects 13 through 29, wherein the downlink message that triggers the random access procedure is a PDCCH order DCI.

Aspect 31: An apparatus for wireless communications at a UE, comprising a processor; memory coupled with the processor; and instructions stored in the memory and executable by the processor to cause the apparatus to perform a method of any of aspects 1 through 12.

Aspect 32: An apparatus for wireless communications at a UE, comprising at least one means for performing a method of any of aspects 1 through 12.

Aspect 33: A non-transitory computer-readable medium storing code for wireless communications at a UE, the code comprising instructions executable by a processor to perform a method of any of aspects 1 through 12.

Aspect 34: An apparatus for wireless communications at a UE, comprising a processor; memory coupled with the processor; and instructions stored in the memory and executable by the processor to cause the apparatus to perform a method of any of aspects 13 through 30.

Aspect 35: An apparatus for wireless communications at a UE, comprising at least one means for performing a method of any of aspects 13 through 30.

Aspect 36: A non-transitory computer-readable medium storing code for wireless communications at a UE, the code comprising instructions executable by a processor to perform a method of any of aspects 13 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
a processor;
memory coupled with the processor; and
instructions stored in the memory and executable by the processor to cause the apparatus to:
receive a control message that indicates a set of timing advance groups, wherein a first timing advance group from the set of timing advance groups is associated with a first control resource set pool index and a second timing advance group from the set of timing advance groups is associated with a second control resource set pool index, and wherein the first control resource set pool index is associated with a serving physical cell identifier;
receive, in response to an initial uplink message of a random access procedure, a first downlink message of the random access procedure, wherein the first downlink message includes one or more reserved bits that indicate one of the first timing advance group or the second timing advance group;
select one of the first timing advance group or the second timing advance group based at least in part on a rule for application of the one or more reserved bits; and
communicate in accordance with a select timing advance group, which is one of the first timing advance group or the second timing advance group, based at least in part on the selection.

2. The apparatus of claim 1, wherein the instructions are further executable by the processor to cause the apparatus to:
receive a second downlink message that triggers the random access procedure and associates the random access procedure with the serving physical cell identifier or an additional physical cell identifier that is different from the serving physical cell identifier, wherein the rule for application of the one or more reserved bits is based at least in part on the random access procedure being associated with the serving physical cell identifier or the additional physical cell identifier.

3. The apparatus of claim 2, wherein the random access procedure is associated with the additional physical cell identifier, and wherein the rule for application of the one or more reserved bits is indicative that the UE is to ignore the one or more reserved bits based at least in part on the random access procedure being associated with the additional physical cell identifier.

4. The apparatus of claim 3, wherein the instructions to select one of the first timing advance group or the second timing advance group are executable by the processor to cause the apparatus to:
select the selected timing advance group based on a configuration associated with the additional physical cell identifier.

5. The apparatus of claim 2, wherein the instructions to select one of the first timing advance group or the second timing advance group are executable by the processor to cause the apparatus to:
select the selected timing advance group based at least in part on the indication of the one or more reserved bits.

6. The apparatus of claim 5, wherein the selected timing advance group is the second timing advance group, and the instructions are further executable by the processor to cause the apparatus to:
delay the communication in accordance with the second timing advance group based at least in part on operation of the UE in an inter-cell mode at a time the first downlink message is received or is to be applied, wherein the second control resource set pool index being associated with one or more transmission configuration indicator states that are associated with an additional physical cell identifier is indicative that the UE is operating in the inter-cell mode.

7. (canceled)

8. The apparatus of claim 5, wherein the instructions to communicate in accordance with the select timing advance group are executable by the processor to cause the apparatus to:
communicate in accordance with the select timing advance group based at least in part on operation of the UE in an intra-cell mode at a time the first downlink message is received or is to be applied, wherein both the first control resource set pool index and the second control resource set pool index being associated with one or more transmission configuration indicator states that are associated with the serving physical cell identifier is indicative of operation of the UE in the intra-cell mode.

9. The apparatus of claim 1, wherein the rule for application of the one or more reserved bits is based at least in part on a multi transmission reception point communication mode of the UE at a time the first downlink message is received or is to be applied.

10-11. (canceled)

12. An apparatus for wireless communications at a user equipment (UE), comprising:
a processor;
memory coupled with the processor; and
instructions stored in the memory and executable by the processor to cause the apparatus to:
receive a control message that indicates a set of timing advance groups, wherein a first timing advance group from the set of timing advance groups is associated with a first control resource set pool index and a second timing advance group from the set of timing advance groups is associated with a second control resource set pool index, and wherein the first control resource set pool index is associated with a serving physical cell identifier;
receive a downlink message that triggers a random access procedure, wherein the downlink message indicates a state from a set of states, and wherein each state from the set of states is associated with a physical cell identifier from a set of physical cell identifiers and is indicative of a timing advance group that is to be used by the UE;
select a selected timing advance group from the first timing advance group, or the second timing advance group based at least in part on the indicated state and on a multi transmission reception point communication mode of the UE; and
transmit an uplink message using the selected timing advance group.

13. The apparatus of claim 12, wherein the set of states comprises a first state that indicates the first timing advance group associated with the serving physical cell identifier from the set of physical cell identifiers, a second state that indicates the second timing advance group associated with the serving physical cell identifier, and one or more third states that each indicate for the UE to transmit the uplink message in accordance with a random access procedure configuration associated with respective additional physical cell identifiers from the set of physical cell identifiers.

14. The apparatus of claim 13, wherein the selected timing advance group is the second timing advance group, and the instructions are further executable by the processor to cause the apparatus to:
transmit an initial uplink message of the random access procedure;
receive a second downlink message in response to the initial uplink message, wherein the second downlink message includes a timing advance command associated with the indicated state; and
delay the transmission of the uplink message using the second timing advance group based at least in part on operation of the UE in an inter-cell multi transmission reception point communication mode at a time the second downlink message is received or is to be applied, wherein the second control resource set pool index being associated with one or more transmission configuration indicator states that are associated with an additional physical cell identifier is indicative of operation of the UE in the inter-cell multi transmission reception point communication mode.

15. The apparatus of claim 14, wherein the instructions to transmit the uplink message are executable by the processor to cause the apparatus to:
transmit the uplink message in accordance with the second timing advance group, after the delay, based at least in part on the second control resource set pool index being associated with the one or more transmission configuration indicator states that are associated with the serving physical cell identifier as a result of activation of the serving physical cell identifier for the second control resource set pool index.

16. The apparatus of claim 12, wherein a quantity of the set of states is based at least in part on the multi transmission reception point communication mode of the UE at a time the downlink message is received or an initial uplink message of the random access procedure is transmitted.

17. The apparatus of claim 16, wherein the instructions are further executable by the processor to cause the apparatus to:
operate the UE in an intra-cell multi transmission reception point mode at the time the downlink message is received or the initial uplink message of the random access procedure is transmitted, wherein the set of states comprises a first state that indicates the first timing advance group associated with the serving physical cell identifier from the set of physical cell identifiers and a second state that indicates the second timing advance group associated with the serving physical cell identifier.

18. The apparatus of claim 17, wherein operation of the UE in the intra-cell multi transmission reception point mode is indicated by the first control resource set pool index and the second control resource set pool index being associated with the serving physical cell identifier.

19. The apparatus of claim 16, wherein the instructions are further executable by the processor to cause the apparatus to:
operate the UE in an inter-cell multi transmission reception point mode at the time the downlink message is received or the initial uplink message of the random access procedure is transmitted, wherein the set of states comprises a first state that indicates for the UE to transmit the uplink message in accordance with a first random access procedure configuration associated with the serving physical cell identifier from the set of physical cell identifiers and one or more second states that indicate for the UE to transmit the uplink message in accordance with a respective random access configuration procedure configuration associated with each additional physical cell identifier from the set of physical cell identifiers.

20. (canceled)

21. The apparatus of claim 12, wherein the set of states comprises a first state that indicates whether the random access procedure is associated with an inter-cell multi transmission reception point communication mode or an intra-cell multi transmission reception point communication mode, a second state that indicates for the UE to transmit the uplink message in accordance with a first random access procedure configuration associated with the serving physical cell identifier from the set of physical cell identifiers, and one or more third states that each indicate for the UE to transmit the uplink message in accordance with a random access procedure configuration associated with respective additional physical cell identifiers from the set of physical cell identifiers.

22-24. (canceled)

25. The apparatus of claim 21, wherein the instructions to select the selected timing advance group are executable by the processor to cause the apparatus to:
determine the selected timing advance group based at least in part on the indicated state in the downlink message that triggers the random access procedure.

26. The apparatus of claim 12, wherein the set of states comprises a first state that indicates for the UE to transmit the uplink message in accordance with a first random access procedure configuration associated with the serving physical cell identifier from the set of physical cell identifiers and one or more second states that indicate for the UE to transmit the uplink message in accordance with an respective random access configuration procedure configuration associated with respective additional physical cell identifiers from the set of physical cell identifiers.

27-28. (canceled)

29. A method for wireless communications at a user equipment (UE), comprising:
receiving a control message indicating a set of timing advance groups, wherein a first timing advance group from the set of timing advance groups is associated with a first control resource set pool index and a second timing advance group from the set of timing advance groups is associated with a second control resource set pool index, and wherein the first control resource set pool index is associated with a serving physical cell identifier;
receiving, in response to an initial uplink message of a random access procedure, a first downlink message of the random access procedure, the first downlink message including one or more reserved bits that indicate one of the first timing advance group or the second timing advance group;
selecting one of the first timing advance group or the second timing advance group based at least in part on a rule for application of the one or more reserved bits; and
communicating in accordance with a selected timing advance group, which is one of the first timing advance group or the second timing advance group, based at least in part on the selection.

30. (canceled)
